(19) United States
(12) Patent Application Publication
(10) Pub. No.: US 2025/0103694 A1
(43) Pub. Date: Mar. 27, 2025

(54) ELECTRONIC APPARATUS AND MEHTOD OF SELECTIVELY APPLYING VARIOUS OPTIONS TO A SECURITY MODE IN A MOBILE DEVICE

(71) Applicant: Seungman Kim, McLean, VA (US)

(72) Inventor: Seungman Kim, McLean, VA (US)

(21) Appl. No.: 18/794,392

(22) Filed: Aug. 5, 2024

Related U.S. Application Data
(60) Provisional application No. 63/649,610, filed on May 20, 2024.
(60) Provisional application No. 63/566,269, filed on Mar. 16, 2024.
(60) Provisional application No. 63/543,475, filed on Oct. 10, 2023.
(60) Provisional application No. 63/541,886, filed on Oct. 1, 2023.
(60) Provisional application No. 63/540,891, filed on Sep. 27, 2023.

(51) Int. Cl. G06F 21/32; H04W 12/30

(52) U.S. Cl. CPC G06F 21/32; H04W 12/35

(57) ABSTRACT

A method of a mobile device includes performing a first user identification process in a security mode by using a first user selection of the network interface, the cameras, and the sensors, unlocking the mobile device according to the first user identification process, performing a second user identification process by using a second user selection of the network interface, the cameras, and the sensors, and maintaining an unlock state of the mobile device according to the second user identification process.

### CROSS-REFERENCE TO RELATED APPLICATIONS

This application claims the benefit of U.S. Provisional Application Nos. 63/649,610 filed on May 20, 2024, 63/566,269 filed on Mar. 16, 2024, 63/543,475 filed on Oct. 10, 2023, 63/541,886 filed Oct. 1, 2023, and 63/540,891 filed Sep. 27, 2023, in the U.S. Patent and Trademark Office, the entire contents of which are hereby incorporated by reference.

### BACKGROUND OF THE INVENTIVE CONCEPT

### 1. Field of the Inventive Concept

The present inventive concept relates to an electronic apparatus and method of selectively applying various options to security mode in a mobile device.

### 2. Description of the Related Art

A conventional electronic mobile device, for example, a cellular phone or smartphone, is set to a non-security mode, a password security mode or a non-password security mode. When a security mode is set with a password, a user has to input the password in the password security mode to unlock the mobile device. When the non-password security mode is set, the mobile device is unlocked by non-password unlock methods. The non-password security mode includes a trusted place mode and a face recognition mode. In the face recognition mode, a user has to place a user face in front of a font camera of a mobile device. In the trusted place mode, a mobile device has to communicate with an external network to be in a trusted place.

A conventional mobile device has been set to use a front camera for a user identification process of a non-password security mode.

A conventional mobile device has been set to use a trusted place for a user identification process of a non-password security mode.

### SUMMARY OF THE INVENTIVE CONCEPT

The present inventive concept provides an electronic apparatus to selectively apply various options to a security mode in a mobile device.

The present inventive concept provides a method of selectively applying various options to a security mode in a mobile device.

The present inventive concept provides a computer-readable medium to contain computer-readable codes as a program to execute a method of selectively applying various options to a security mode in a mobile device.

Additional features and utilities of the present inventive concept will be set forth in part in the description, which follows and, in part, will be obvious from the description, or may be learned by practice of the present inventive concept.

The foregoing and/or other features and utilities of the present inventive concept may be achieved by providing a non-transitory computer-readable medium containing computer-readable codes as a program to execute a method in a mobile device having a network interface, cameras and sensors, and a panel to display a menu and an image. The method may include performing a first user identification process in a security mode by using a first user selection of the network interface, the cameras, and the sensors, unlocking the mobile device according to the first user identification process, performing a second user identification process by using a second user selection of the network interface, the cameras, and the sensors, and maintaining an unlock state of the mobile device according to the second user identification process.

The method may further include locking the unlocked mobile device when the second user identification process fails.

The method may further include detecting an unusual activity by using at least one of the network interface, the cameras, and the sensors. The performing the second user identification process may further include performing the second user identification process by using at least one of the network interface, the cameras in response to the detected unusual activity.

The unusual activity may include at least one of a sound, an image, and a motion of the mobile device.

The method may further include detecting a condition by using the network interface, the cameras, and the sensors. The performing the second user identification process may further include performing the second user identification process by using the network interface in response to the detected condition.

The first user identification process may include a face recognition process, and the second user identification process may include at least one of a trusted place and a trusted device.

The first user identification process may include at least one of a trusted place and a trusted device, and the second user identification process may include a face recognition process.

The first user identification process may include a user body portion recognition process, and the second user identification process may include at least one of a trusted place and a trusted device.

The first user identification process may include at least one of a trusted place and a trusted device, and the second user identification process may include a user body portion recognition process.

The first user identification process may include an object recognition process, and the second user identification process may include at least one of a trusted place and a trusted device.

The first user identification process may include at least one of a trusted place and a trusted device, and the second user identification process may include an object recognition process.

The first user identification process may include a first level of a user identification process, and the second user identification process may include a second level of the user identification process.

The first user identification process may include an internal communication process between the mobile device and a user, and the second user identification process may include an external communication process between the mobile device and the external device.

The first user identification process may include an external communication process between the mobile device and the external device, and the second user identification process may include an internal communication process between the mobile device and a user.

The first user selection of the network interface, the cameras, and the sensors may further include a user selection of at least one of the cameras.

The second user selection of the network interface, the cameras, and the sensors may further include a user selection of at least one of the cameras.

The first user selection of the network interface, the cameras, and the sensors may further include a user selection of at least one of a back camera and a front camera.

The method may further include unlocking the mobile device to a public mode according to the first user identification process, and unlocking the mobile device to a private mode according to the second user identification.

The method may further include unlocking the mobile device to a public mode according to the first user identification process, and changing the mobile device from the public mode to a private mode according to the second user identification process.

The unlocking the mobile device according to the first user identification process may further include unlocking the mobile device according to the first user identification process and a first time condition, and the maintaining an unlock state of the mobile device according to the second user identification process may further include maintaining an unlock state of the mobile device according to the second user identification process and a second time condition.

The method may further include unlocking the mobile device to a normal mode according to a main address of a location, and unlocking the mobile device to the normal mode according to an expanded area including the main address and an adjacent address.

The method may further include unlocking the mobile device to a normal mode according to a main address of a location, and maintaining the normal mode of the mobile device according to an expanded area including the main address and an adjacent address.

The method may further include unlocking the mobile device to a normal mode according to a main address of a location, and maintaining the normal mode of the mobile device according to an expanded area expanded from the main address to cover an adjacent address.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIGS. 1A, 1B, and 1C are block diagrams illustrating a mobile device according to embodiments of the present inventive concept;

FIG. 2 is a block diagram illustrating a mobile device according to an embodiment of the present inventive concept;

FIGS. 3A, 3B, and 3C are diagrams illustrating images for security modes according to embodiments of the present inventive concept;

FIGS. 4 and 5 are block diagrams illustrating a panel of a mobile device according to embodiments of the present inventive concept;

FIGS. 6 and 7 are blocking diagrams illustrating a screen of a panel of a mobile device according to embodiments of the present inventive concept;

FIGS. 8, 9, and 10 are flowcharts illustrating a method of a mobile device according to embodiments of the present inventive concept;

FIG. 11 is a flowchart illustrating a setting method of a mobile device according to an embodiment of the present inventive concept;

FIG. 12 is a flowchart illustrating a method of a mobile device according to an embodiment of the present inventive concept;

FIGS. 13A, 13B, and 13C are diagrams illustrating second user faces according to embodiments of the present inventive concept;

FIGS. 14A, 14B, and 14C are diagrams illustrating second trusted places according to embodiments of the present inventive concept;

FIGS. 15A, 15B, and 5C are block diagrams illustrating an electronic terminal to selectively perform a public mode and a private mode with selective security mode in a mobile device according to an embodiment of the present inventive concept;

FIGS. 16A, 16B, 16C, and 16D are diagrams illustrating an electronic terminal to set and be unlocked by various methods according to an embodiment of the present inventive concept;

FIG. 17 is a diagram illustrating a method of setting an application to a public mode and a private mode in a mobile device according to an embodiment of the present inventive concept;

FIG. 18 is a diagram illustrating a method of setting applications to a public mode and a private mode in a mobile device according to an embodiment of the present inventive concept;

FIG. 19 is a flowchart illustrating a method of selectively applying a public mode and a private mode in a mobile device according to an embodiment of the present inventive concept;

FIG. 20 is a flowchart illustrating a method of selectively applying a public mode and a private mode in a mobile device according to an embodiment of the present inventive concept;

FIG. 21 is a flowchart illustrating a method of selectively applying a public mode and a private mode in a mobile device according to an embodiment of the present inventive concept;

FIG. 22 is a flowchart illustrating a method of setting and applying security modes to a menu of a mobile device according to an embodiment of the present inventive concept;

FIG. 23 is a flowchart illustrating a method of setting and apply security modes to a menu of a mobile device according to an embodiment of the present inventive concept;

FIG. 24 is a flowchart illustrating a method of setting and applying a combination of security modes in a menu of a mobile device according to an embodiment of the present inventive concept; and

FIG. 25 is a flowchart illustrating a method of setting and applying levels of security modes to a menu of a mobile device according to an embodiment of the present inventive concept;

FIG. 26 is a diagram illustrating a mobile device to perform unlocking methods according to an embodiment of the present inventive concept;

FIG. 27 is a diagram illustrating a method of a mobile device to detect an unusual activity and to perform a secondary unlocking method according to an embodiment of the present inventive concept;

FIG. 28 is a flowchart illustrating a method of a mobile device to detect an unusual activity during an unlocking method, and to perform a secondary unlocking method according to an embodiment of the present inventive concept;

FIG. 29 is a flowchart illustrating a method of a mobile device to perform a primary unlocking method and secondary unlocking method a time period after unlock according to an embodiment of the present inventive concept; and

FIG. 30 is a diagram illustrating a mobile device including setting menus according to the present inventive concept.

### DETAILED DESCRIPTION OF THE EXEMPLARY EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept while referring to the figures.

A mobile device, for example, a cellular phone, a smartphone, or a computer device, may be set to a non-security mode and a security mode which includes a password security mode and a non-password security mode. When the mobile device is in the non-security mode, the mobile device is unlocked without a password. When the password security mode is set with a password, a user has to input the password in the password security mode to unlock the mobile device. When the non-password security mode is set, the mobile device is unlocked by non-password unlock methods.

A mobile device provides various options to be selectively applied to a security mode such that the mobile device is unlocked, the unlocked mobile device is maintained, and the unlocked mobile device is locked, according to one or more user identification processes and the various options. The various options and the one or more user identification have been described above and will be described below.

The non-password security mode includes an internal condition mode, for example, a face recognition mode, and an external condition mode, for example, a trusted place or trusted device mode.

In the face recognition mode, a user has to place a user face in front of a font camera of a mobile device. In the trusted place mode, a mobile device has to communicate with an external network to be in a trusted place. The face recognition mode may be a biometric recognition mode to determine an authorized user of a mobile device. The mobile device may provide different options to be applied to the security mode or the non-password security mode to determine an authorized user of the mobile device.

In the trusted place mode, a mobile device has to communicate with an external network to be in a trusted place. The mobile device may provide different options to be applied to the security mode or the non-password security mode to determine an authorized user of the mobile device.

One or more cameras of a mobile device may be set to perform a user identification process in the security mode. One or more images captured by one or more cameras may be usable in the user identification process in the security mode to determine an authorized user of the mobile device.

One or more options may be set to be applied to a user identification process in the security mode. The options may include one or more conditions to be applied to a user identification process in the security mode. The conditions may be one or more activities detected by the mobile device. The conditions may be a condition of an external device usable to unlock the mobile device. The conditions may be a strength or weakness of a signal received from the external device to apply different user identification process to the security mode to unlock the mobile device, to maintain an unlock state of the mobile device, or to lock the unlocked mobile device The options may include different user identification processes to be selectively applied to the security mode to unlock the mobile device, to maintain an unlock state of the mobile device, or to lock the unlocked mobile device. A first user identification process and a second user identification process are performed according to the various options.

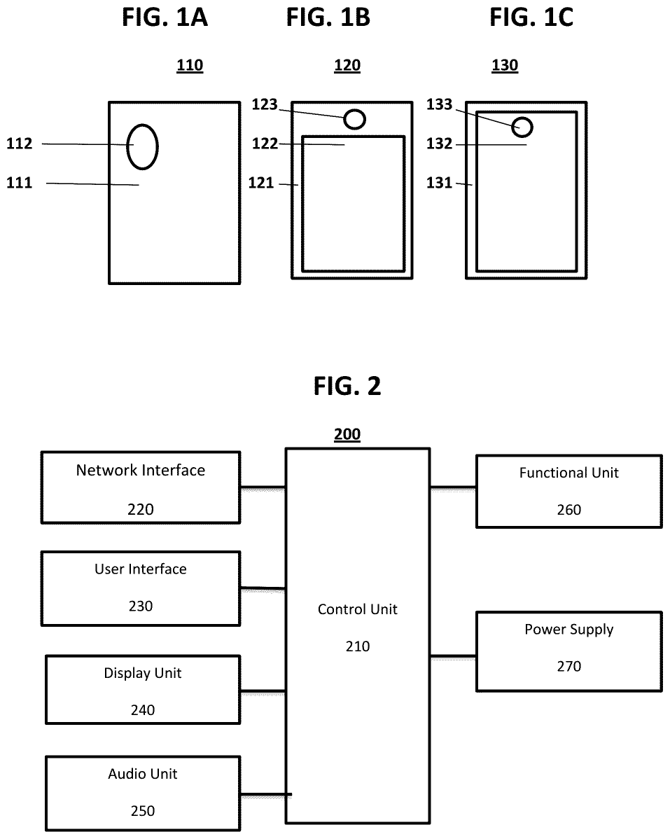

FIG. 1A illustrates a mobile device 110 according to an embodiment of the present inventive concept. The mobile device 110 may be a computer apparatus, a portable personal computer, a mobile electronic device, a mobile phone, a smartphone, a mobile tablet apparatus, a mobile tablet computing apparatus, an audio or video recording and/or reproducing apparatus, a photographing apparatus, a communication device, etc. FIG. 1A illustrates a back side housing 111 of the mobile device 110 and also illustrates a back side camera (or back camera) 112 as a main shooter to perform a photographing mode to photograph an object and to generate a photographed object to be displayed on a screen of a front panel of the mobile device 110. The back side camera 112 is installed in a back side housing 111 and exposed through a hole of the back side housing 111. When the object is a user, the photographed object may be a photographed user. The photographed object and the photographed user may be referred to as a photographed image. The back side camera 112 may be usable in a first sensing mode as a user identification process, to sense a user to generate a sensed image as an authorized user to be usable to unlock the mobile device or to verity a user identity in one or more applications or payment applications of the mobile device 110.

FIG. 1B illustrates a mobile device 120 according to an embodiment of the present inventive concept. FIG. 1B illustrates a front side housing 121, a panel 122 and a front camera 123 of the mobile device 120. The back side housing 111 and the front side housing 121 may be referred to as a housing. The panel 122 is disposed in the front side housing 121. The panel 122 may include a screen to display a state section and a user menu section which includes one or more user menus. The panel 122 may include a screen to display a menu, image, or photographed image thereon. The front camera 123 may be usable in a photographing mode (or selfie mode) to photograph a user by using at least one of a front camera and a back camera to generate an image or a first sensed image of a first sensing mode. The front camera 123 may be usable in a second sensing mode to sense or photograph a user to generate a second sensed image usable to unlock the mobile device or to verity a user identity in one or more applications or payment applications of the mobile device 120. The first sensed image and the second sensed image may be referred to as a sensed image. The first sensing mode and the second sensing mode may be referred to as a sensing mode for a security mode. The sensing mode may be useable as a face recognition security mode to unlock the mobile device with the sensed image or to verify a user identity in one or more applications or payment applications of the mobile device 120. The sensing mode is performed in a security mode. Other sensing mode may be usable to unlock the mobile device or to verity a user identity in one or more applications or payment applications of the mobile device 120. The other sensing mode may be a fingerprint mode, a trusted place mode, a trusted device mode, etc. The above-described sensing modes correspond to various user identification process of a security mode. The present inventive concept is not limited to the above-described other sensing mode and the security mode.

The panel 122 may be formed with a display film to display an image and/or a menu and a touch film to receive a user touch input as a password or a user input to correspond to the menu to control at least one function of the mobile device 120.

FIG. 1C illustrates a mobile device 130 according to an embodiment of the present inventive concept. FIG. 1C illustrates a front side housing 131, a panel 132 and a front camera 133 of the mobile device 130. The back side housing 111 and the front side housing 131 may be referred to as a housing. The panel 132 is disposed in the front side housing 131. The panel 132 may include a screen to display a state section, which includes one or more state menus, and a user menu section which includes one or more user menus. The panel 132 may include a screen to display the photographed image. The front camera 133 may be usable in a selfie mode to photograph a user to generate a selfie image. The front camera 133 may be usable in a second sensing mode to sense or photograph a user to generate a second sensed image usable to unlock the mobile device or to verity a user identity in one or more applications or payment applications of the mobile device 130. The first sensed image and the second sensed image may be referred to as a sensed image. The first sensing mode and the second sensing mode may be referred to as a sensing mode for a security mode. The sensing mode may be a face recognition security mode to unlock the mobile device with the sensed image or to verify a user identity in one or more applications or payment applications of the mobile device 130. The sensing mode is performed in a security mode. Other sensing mode may be usable to unlock the mobile device or to verity a user identity in one or more applications or payment applications of the mobile device 130. The other sensing mode may be a fingerprint mode, a trusted place mode, a trusted device mode, etc. The above-described sensing modes correspond to various user identification process of a security mode. The present inventive concept is not limited to the above-described other sensing mode and the security mode.

The panel 132 may be formed with a display film to display an image and/or a menu and a touch film to receive a user touch input as a password or a user input to correspond to the menu to control at least one function of the mobile device 130.

The front camera 133 may be referred to as a punch-hole camera, an in-display camera, or an under-display camera. The front camera 133 is disposed at a transparent portion of the panel 132 to prevent the cameras from being interfered during photograph an object or a user. The panel 132 includes a majority portion and a small portion corresponding to the transparent portion which is formed in the majority portion. The majority portion may be a large area and the small portion may be a small area to correspond to a size of the front camera 133.

Although FIGS. 1A, 1B, and 1C respectively illustrate a back camera 112 and a front camera 123 or 133, the back camera 112 may be a plurality of back cameras, and the front camera 123 or 133 may be a plurality of front cameras. At least one of the back cameras and the front cameras may be a user-selected camera for photographing an object. It is possible that at least one of the back cameras and the front cameras may be a user-selected camera for sensing mode of a security mode. It is also possible that a combination of the front and back cameras may be a user-selected camera for a sensing mode of a security mode. It is also possible that the back camera 112 may be useable for a sensing mode of a security mode. When the back camera 112 may have a higher resolution than that of the front camera 123 or 124, the back camera 112 may be usable for at least a portion of a sensing mode of a security.

The mobile device may be set with a first user identification process for a security mode. The first user identification process may include a face recognition by using a front camera, a trusted place by using communication with an external device, a fingerprint by using a fingerprint sensor, etc. The mobile device may be set with a second user identification process for a security mode. The second user identification process may include a second face recognition or an object recognition (hereinafter, referred to as a second face recognition) by using a back or front camera and/or another front camera, a second trusted place of an extended area by communicating with an external device, a second fingerprint by using a second sensor with a second resolution, etc. When the mobile device is a foldable mobile device with two panels on respective front sides of the foldable mobile device. In this case, the foldable mobile device may have a plurality of front cameras on each panel of each front side of the foldable mobile device and also may have one or more back cameras which may be a higher resolution for the face recognition. At least one of the back cameras and the front cameras may be usable for the sending mode of a security mode. The front camera is a near image camera to photograph an object near the mobile device, and the back camera is a distance image camera to photograph on object distant from the mobile device. One or more of the near image camera and the distance image camera may be usable for the sensing mode of a security mode.

When the front camera is an under-display camera, a resolution of the under-display camera may be lower than other front cameras. It is possible that the resolution of the front camera is not sufficient to recognize an authorized user for the user identification process. A user may have an option to select at least one of the front camera and the back camera as a user-selected camera for the face recognition or the user identification process in a security mode.

When the mobile device is a foldable mobile device, the mobile device may be in a folding state and an unfolding state. In the folding state, the mobile device has a first front side with a first panel and a first front camera, and also has a first back side with a back panel and a back camera. In the unfolding state, the mobile device has a second front side with a second panel and a second front camera and also has a second back side including the first front side with the first panel and the first front camera and the first bac side with the back panel and the back camera. The second front side of the mobile device may not be not seen in the folding state since the second front side is folded. However, the second front side of the mobile device may be exposed to face a user in the unfolding state.

In the folding state, the first front camera and/or the back camera may be usable for the face recognition or the user identification process. In the unfolding state, at least one of the first front camera, the back camera, and the second front camera may be usable for the face recognition or the user identification process. The second front camera may be unfolded to be in front of a user face so that the second front camera may be usable for the face recognition or the user identification process. However, the second front camera may be folded to not be seen by a user. Accordingly, the first front camera, the back camera, and/or the second front camera may be set to be usable for the face recognition or the user identification process according to the folding state and the unfolding state of the foldable mobile device.

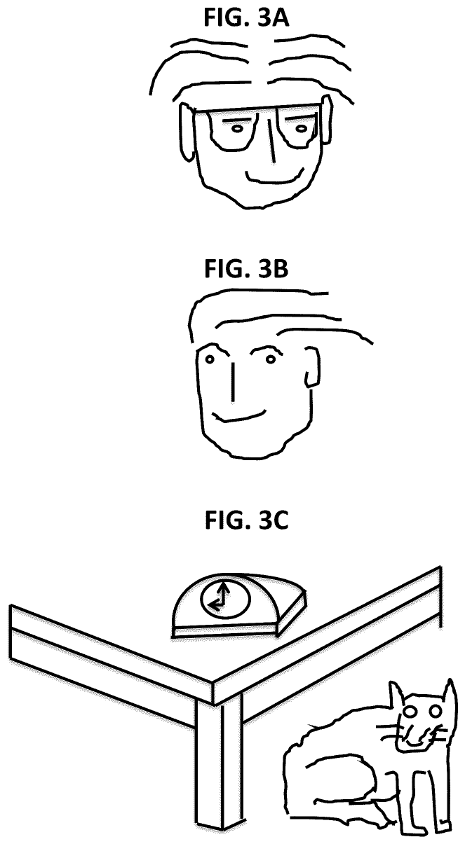

FIG. 2 is a block diagram illustrating a mobile device 200 according to an embodiment of the present inventive concept. The mobile device 200 may include components, such as a control unit 210, a network interface 220, a user interface 230, a display unit 240, an audio unit 250, one or more functional units 260, and a power supply unit 270 including a battery and a battery charging unit. The components may be disposed in or on a housing of the mobile device 200.

The control unit 210 may control at least one of the components or at least one of the network interface 220, the user interface 230, the display unit 240, the audio unit 250, the one or more functional units 260, and the power supply unit 270. The control unit 210 may control at least one of the one or more applications and payment applications of the mobile device 200. The control unit 210 may control operations of the mobile device 200 and may include a computer-readable medium or a data storage unit, for example, a semiconductor memory unit. The control unit 210 may be connected to an external data storage unit disposed in the housing of the mobile device 200. The housing of the mobile device 200 may include a port such that another external data storage can be detachably attached to the port of the housing of the mobile device 200, and the port may be connected to the control unit 210 to transmit and receive data as a function of the mobile device 200. When the user interface 230 is referred to as a user input panel, for example, a touch panel layer or a touch film, the control unit 210 may include an input interface to control the user input panel. When the display unit 240 is referred to a menu/image display panel, for example, a display panel layer or a display film, the control unit 210 may be referred to as an output interface to control the display panel.

The network interface unit 220 may to communicate with an external apparatus (or external network apparatus), for example, a WiFi device, a Bluetooth device, an access point (AP), another device, another mobile device, or a mobile carrier station. The network interface unit 220 may detect a signal from the external apparatus. The network interface unit 220 may include a sensor to detect a signal of the external apparatus. The network interface unit may communicate with the external apparatus to receive and transmit data to perform a function of the mobile device. The mobile device 200 may perform an external mode with the network interface unit 220 and the external device, as a user identification mode to unlock the mobile device. The external mode may include a main place unlock mode, an extended place unlock mode, and a trusted device mode to unlock the mobile device in the security mode.

The user interface unit 230 may receive a user input to control operations of the mobile device 200. The user interface unit 230 may include a physical button or key board such as QWERTY keyboard. The user interface unit 230 may have a sensor to detect a user gesture as a user input. The user interface unit 230 may include a microphone to detect a user voice as a user input. The user interface unit 230 may be a sensor to detect an image as a user input. The user interface unit 230 may be a touch panel. A user may enter a password to the user interface unit 230 to unlock the mobile device 200 in the security mode.

The display unit 240 may include the panel 122 or 132 to perform a function of the mobile device 200. The display unit 240 may include a display panel including a screen to display an image corresponding to operations of the mobile device 200. The user interface unit 230 and the display unit 240 may be formed as a single body, that is, a panel of the touch panel and the display panel. The user interface unit 230 and the display unit 240 may be referred to as a user interface unit. The audio unit 250 may be a speaker and/or a microphone.

The one or more functional units 260 may be a photographing unit having one or more cameras to photograph an object and to generate a signal corresponding to the photographing object and/or to sense a user to generate a sensed user, a fingerprint sensor to detect a fingerprint to generate a signal correspond to the sensed fingerprint. The signal of the sensed user or fingerprint may be usable to unlock the mobile device 200 and/or to verify a user identity to process the one or more applications or the payment applications of the mobile device 200. The photographing unit may be a camera or sensor to photograph or sense a user including a fingerprint. The photographing image or sensed user may be displayed on the panel 120 or 130 of FIG. 1 or may not be displayed on the panel 120 or 130 of FIG. 1 according to a user preference or a manufacturers preference of the mobile device 200. The signal may be processed in the control unit 210, displayed in the display unit 240, and/or transmitted to an external apparatus through the network interface unit 220 to perform a function of the mobile device 200. The mobile device 200 may perform an internal mode to unlock the mobile device in the security by using the photographing image or a sensed image of the one or more functional units 260. The function of the mobile device 200 may be any operation with the photographed image or sensed user. The present inventive concept is not limited thereto. The one or more functional units 260 may include an application menu unit to perform an application for an application menu of the mobile device 200.

The power supply unit 270 may be connectable to an external power source using a wired and/or wireless method.

The control unit 210 may selectively perform a security mode according to a condition set by a user. The control unit 210 may selectively activate the one or more cameras for a photographing mode and/or a sensing mode. The photographing mode and the sensing mode may be the security mode usable to unlock the mobile device 200 or to verity a user identity in one or more applications or payment applications of the mobile device 200. The control unit 210 may perform an unlocking operation to change the mobile device from a power-off, deactivation, sleep, and/or power saving mode to a power-on, activation, wake-up, and/or normal mode. The normal mode may be usable as a common function of the mobile device 200 or may be usable differently, according to a design or user preference. The normal mode may be a full functional mode of the mobile device 200.

The security mode may include a password input mode or a non-password mode to unlock the mobile device with the sensed image or to verify a user identity in one or more applications or payment applications of the mobile device. The password input mode includes a password input through a panel of a mobile device. The user needs to touch the panel to enter the password. In the non-password mode, a user does not need to touch the panel to enter the password. In the non-password mode, a user has to put the mobile device in front of the user face, or the mobile device has to communicate with an external device. The non-password mode may include a face recognition, a fingerprint, a trusted place, a trusted device, etc., useable to unlock the mobile device with the sensed image or to verify a user identity in one or more applications or payment applications of the mobile device, without the password input. In the non-password mode, the mobile device may use a selection of one or more cameras of a front camera and a back camera, may use selection of various photographed or sensed images, may user a selection of a portion of the photographed or sensed images, and may use a secondary condition, for example, a time condition, a trusted place, a trusted device, etc. If the mobile device is not in the time condition, the mobile device is unlocked by the password. If the mobile device is in the time condition, the mobile device is unlocked without the password by a non-password mode including a user-selected one of the cameras, a portion of a set image, and a secondary condition.

The mobile device 200 further includes a switch to perform a user identification process as the security mode to unlock the mobile device or to verify a user identification for one or more applications and payment applications in the mobile device. The user identification process can be activated by the switch. The switch may be a button of the panel or a sensor to sense a motion of the mobile device. The user identification process can be activated by an operation of the one or more applications and payment applications in the mobile device.

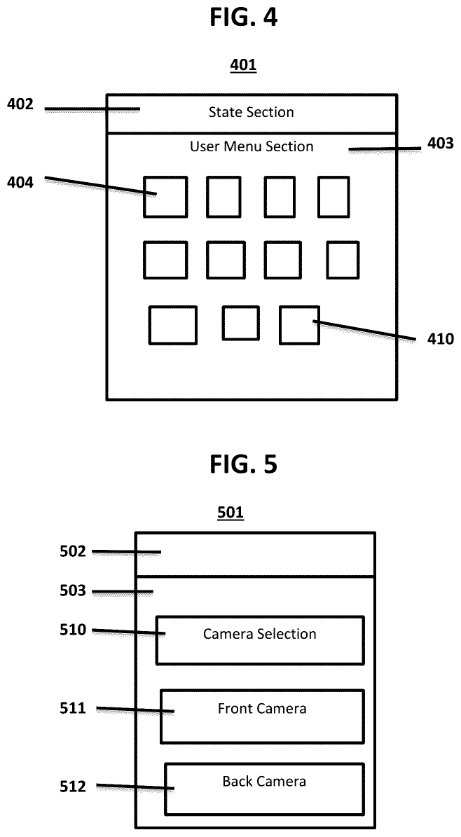

FIGS. 3A, 3B, and 3C are diagrams illustrating images 301, 302, and 303 for security modes according to embodiments of the present inventive concept. The image 301 may be a user image taken from a back camera 112 or a front camera 123 or 133 for the security mode. The image 301 may be a set user image including eye-opening and/or glasses. The mobile device may use a portion of the set user mage. The portion of the set user image may be less secure than the set user image to perform a function of the mobile device, for example, unlocking and verifying. The portion of the set user image may be usable together with a secondary condition to perform a function of the mobile device, for example, unlocking and verifying. The set user image or the portion of the set user image may be usable together with a user selected one of cameras of a front camera and a back camera, to perform a function of the mobile device, for example, the unlocking and verifying. The present inventive concept is not limited thereto. The user image may be a user body portion with a tattoo. The user image may be a user palm with palm lines. The user image may be a user body portion with a pattern of blood vessels. The user image may be a back of a user hand with a blood vessel pattern and/or a wrinkle pattern. The user image may be an object image which is unique to a user.

In this case, a user does not have to put the mobile device in front of a user face. The user image may be a combination of, for example, a user face and a user body portion other than the user face. The user image may be a combination of a user tattoo and a user body portion. The user image of a first user identification process may be different from the user image of a second user identification process. The images 301, 302, and 303 may be a still image or a video image, may be a combination of still images, or may be a combination of a still image and the video image. The user image is compared with an image stored in a memory, and the user image is determined as an authorized user of the mobile device according to the comparison. A user may set one or more user images to selectively be applied to user identification processes of a security mode in a mobile device.

The image 301 may be a default image for the security mode. The image 302 may be a second user image taken from the back camera 112 or the front camera 123 or 133 for the security mode. The image 302 may be a portion of the image 301 or may be a portion of a user body, for example, a user finger, fist, palm, etc. The image 303 is an object image taken from the back camera 112 or the front camera 123 or 133 for the security mode. The images 301, 302, and 303 may be taken by the front camera 123 or 133. The images 301, 302, and 303 may be usable to unlock the mobile device 200 or to verity a user identity in one or more applications or payment applications of a mobile device. The image 301 may be a user face image with open eyes or with eye-glasses. The image 302 may be a second person image. The image 303 may be an image of a table, furniture, pet, or any object around the user. The image 303

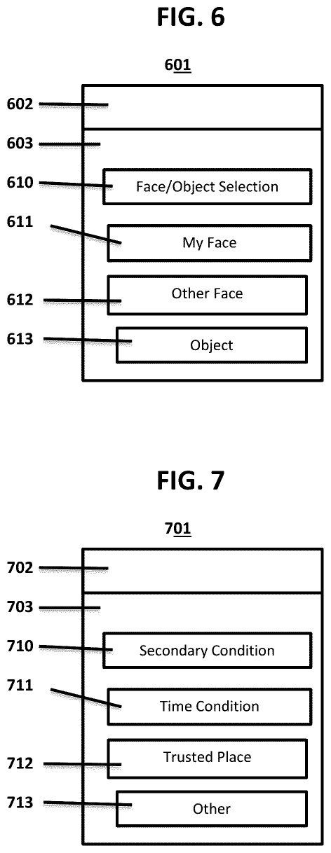

FIGS. 4 and 5 are block diagrams illustrating panels 401 and 501 of a mobile device according to embodiments of the present inventive concept. Referring to FIG. 4, the panel 401 may include a display film and a touch film. The panel 401 may include a screen to display an image or a photographing image. The panel 401 may include a screen with a state section 402 and a user menu section 403. The state section 402 may include state icons representing state of the mobile device, for example, a clock, a connection state of an external network or external device, etc. The use menu section 403 may include one or more menus 404 including a security setting menu including a face recognition menu 410 as a mode of security modes. The security setting menu may include an unlock condition setting menu, a user verification setting menu, etc., usable to unlock the mobile device or to verity a user identity in one or more applications or payment applications of the mobile device. The face recognition menu 410 may be a menu to set a security mode usable to unlock the mobile device or to verity a user identity in one or more applications or payment applications of the mobile device. The face recognition menu 410 may be a menu to set a face recognition security as the security mode. Since the panel 401 includes the touch film, the mobile device receives a user input to a portion of the touch film. The face recognition menu 410 may include a menu for a user to select one or more cameras to perform a face recognition process as a user identification process. Since the panel 401 includes the touch film, the mobile device receives a user input to a portion of the touch film corresponding to the face recognition menu 410 displayed on the display film of the panel 401.

The panel 501 may include a screen with a state section 502 and a user menu section 503. The panel 501 displays a camera selection menu 510 to select at least one of cameras which include one or more front cameras 511 and/or one or more back cameras 512. The panel 501 illustrates one front camera 511 and one back camera 512 to be selected for a sensing mode of a user identification process. However, the present inventive concept is not limited to one front camera and one back camera. The front camera 511 and/or the back camera 512 may be selected for the sensing mode of the user identification process and/or the security mode.

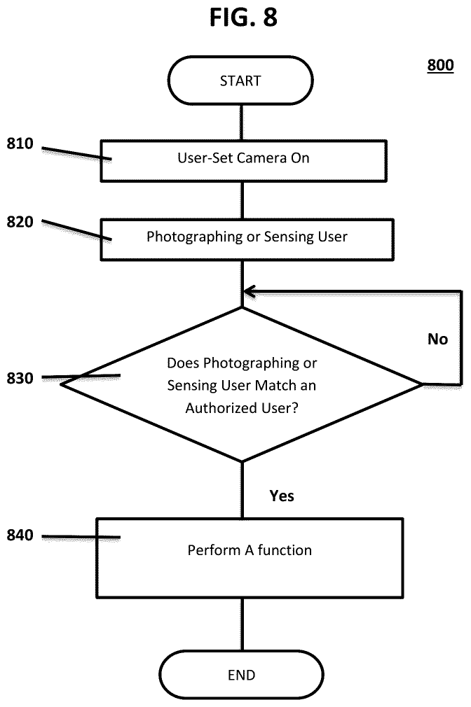

FIGS. 6 and 7 are blocking diagrams illustrating screens of panels 601 and 701 of a mobile device according to embodiments of the present inventive concept.

The panel 601 displays a screen to display a face/object selection menu 610 to select a face (my face or user face) 611, another face 612, and an object 613, according to a selection of the front camera 511 or the back camera 512 of the panel 501.

Any combination of my face 611, other face 612, and object 613 may be usable for the security mode. Any combination of my face 611, other face 612, and object 613 may be assigned to the front camera 511 and/or the back camera 512. When my face 611 and the front camera 511 are set as a default mode of a face recognition security mode as the security mode of the mobile device, other face 612 and/or object 613 may be set for the front camera 511 of FIG. 5. It is possible that my face 611, other face 612, and/or object 613 may be set for the back camera 512.

The panel 701 displays a screen with a state section 702 and a user menu section 703. The panel 701 may include a screen to display a secondary security condition 710 including one or more conditions, for example, a time condition, 711, trusted place condition 712, and other condition 712 which includes a trusted device or a watch, etc. The time condition is a period of time in which one of the conditions can be combined with at least one of my face 611, other face 612, and object 613 for the face recognition security of the security mode, or in which the combination of my face 611, other face 612, and object 613 are allowed as the security mode, to unlock the mobile device with the sensed image or to verify a user identity in one or more applications or payment applications of the mobile device. The secondary security condition 710 may be combined with the face selection 610 to unlock the mobile device with the sensed image or to verify a user identity in one or more applications or payment applications of the mobile device.

When my face 611 and the front camera 511 are set as a default mode of a face recognition security mode as the security mode of the mobile device, a user has to hold the mobile device in front of a use face so that the front camera can sense a user face including, for example, eye-opening and/or glasses which may be a required portion of the user face. However, a user may not hold the mobile device in front of the user face to detect the required portion of the user face, and then the front camera is unable to sense my face 611 as a user face for user face recognition in the security mode. In this case, the mobile device can be set to use the front camera for other face 612 which is a portion of my face 611 or a secondary person's face. It is possible that the device can be set to use the back camera for other face 612 or the object 613 as a user face for user face recognition. It is possible that a combination of other face 612, which is a portion of my face 611, and the trusted place in the security mode, a user can unlock the mobile device with other face 612 which is a portion of my face 611 when the user is in the trusted place, for example, a home location. In this case, the front camera senses a portion of my face 611 and the mobile device determines that the user is in the trusted place. According to the sensed portion of my face 611 and the trusted place, the mobile device can be unlocked for the security mode.

It is possible that other face 612 and/or object 613 may be combined with my watch (or user watch) as the trusted device to unlock the mobile device with the sensed image or to verify a user identity in one or more applications or payment applications of the mobile device. The other face 612 may be a user finger. The front camera or back camera can photograph the user finger to generate the photographed user finger usable to unlock the mobile device to verify a user identity in one or more applications or payment applications of the mobile device. When the back camera has a higher resolution than the front camera, the user finger image taken by the back camera is more accurate, useful, and effective in the security mode. When a user is unable to touch the mobile device or put the front camera in front of a user face, the use of the photographed finger image taken by the back camera is more effective to achieve unlocking the mobile device or verifying a user identity in one or more applications or payment applications of the mobile device.

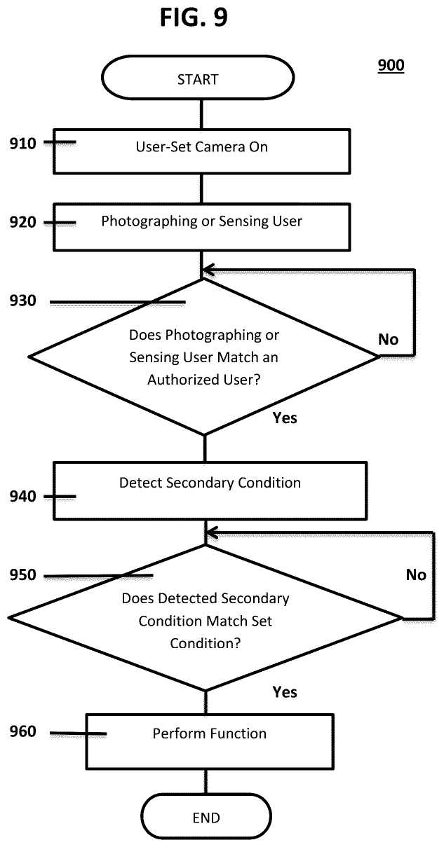

FIGS. 8 through 10 are flowcharts illustrating methods 800, 900, and 1000 of a mobile device according to embodiments of the present inventive concept.

The method 800 includes operation 810 of activating a camera which may be a front camera and/or a back camera, operation 820 of photographing or sensing a user or an object and generating photographed or sensed user or object, operation 830 of determining whether the photographed or sensed user or object matches an authorized user as a user identification, and operation 840 of performing a function of the mobile device, for example, unlocking the mobile device or verifying a user identity in one or more applications or payment applications of the mobile device. The function of the mobile device is not limited thereto. It is possible that the function can be any other function than the unlocking and verifying.

The method 900 includes operation 910 of activating a camera which may be a front camera and/or a back camera, operation 920 of photographing or sensing a user or an object and generating photographed or sensed user or object, operation 930 of determining whether the photographed or sensed user or object matches an authorized user as a user identification, operation 940 of applying a secondary security, operation 950 of performing detection of the secondary security, operation 960 of determining whether detected second security matches the preset secondary security, and operation of performing a function of the mobile device, for example, unlocking the mobile device or verifying a user identity in one or more applications or payment applications of the mobile device. The function of the mobile device is not limited thereto. It is possible that the function can be any other function than the unlocking and verifying.

The method 1000 includes operation 1010 to set a user-selected one of cameras of the mobile device, operation 1020 of set a face or object selection for an authorized user or user verification in the security mode, operation 1030 of set a secondary condition to be combined with the user selected camera and/or the selected face/object. The cameras may be a front camera and/or the back camera as shown in FIGS. 1A, 1B, and 1C. The face or object may be at least one of images 301, 302, and 303 respectively illustrated in FIG. 3A, 3B, 3C, or an image illustrated in FIG. 6. The secondary condition may be a condition illustrated in FIG. 7.

As described above, a mobile device may be in a security mode. When the mobile device is not in the security mode, the mobile device is not locked but unlocked to change a power saving mode to a normal mode in response to an operation of a switch. The mobile device may be in the security mode when a user sets a password. The mobile device may be unlocked from a power saving mode to a normal mode in response to a password input through a panel having a display panel and a touch panel. When an application of the mobile device requires a password input to verify a user identity, the application operates in response to the verified user identity.

The security mode may include a password mode as described above. The security mode may further include a non-password mode in which the mobile device does not require a password but require a user identification process to unlock the mobile device to a normal mode. The user identification process may include recognizing a user face, scanning a user fingerprint, detecting a trusted place in which the mobile device is located, detecting a trusted device with which the mobile device communicates, detecting an on-body according to a first state of a movement of the mobile device, etc. The first state of the movement of the mobile device may be a continuation of the movement.

However, the use identification process may require an accurate user identification process. For example, the face recognition may require photographing a user face to generate an accurate user face image which is identical to a reference image stored in a memory of the mobile device, so that the mobile device is unlocked by comparison between the user face image and the stored reference image. When the face recognition requires an eye opening or wearing glasses, the mobile device may not be unlocked by the face recognition without the eye opening or the glasses in the user face image. For example, when a user wears a face mask, the mobile device may not recognize the user with the face mask as an authorized user. When a user wears a sunglass, the mobile device may not recognize the user with sunglass. In this case, the mobile device is not unlocked and then require a password to perform an unlock operation.

When the trusted place requires an accurate location, for example, an address of a house location, the mobile device may not be unlocked by a detected address which is not the trusted place. In this case, the mobile device is not unlocked and then require a password to perform an unlock operation. The user fingerprint unlock requires a full fingerprint image to unlock the mobile device, and a partial fingerprint image may be usable to unlock the mobile device. The trusted device unlock requires a communication with the mobile device, and a incomplete communication or a partial data of the communication may not us usable to unlock the mobile device. The on-body unlock requires a continuing motion of the mobile device, and a partial motion may not be usable to unlock the mobile device. The mobile device may set an expanded area, which is expanded from the trusted place of an address, useable to unlock the mobile device, maintain an unlock state of the mobile device or lock the unlocked mobile device. A first user identification process including the trusted place and a second user identification process including the external place and the face recognition may be useable to unlock the mobile device according to a signal condition of the external device. The signal condition may be a strength of the signal received from the external device. The present inventive concept is not limited thereto. Any combination of user identification processes may be usable to unlock the mobile device according to the signal condition.

The non-password mode may be usable with a time condition. For example, when the mobile device is in the time condition, the user identification process is performed to unlock the mobile device. When the mobile device is not in the time condition, the user identification is not performed. Instead, a password is required to unlock the mobile device. The time condition may be a period of time, for example, 4 hours or 24 hours.

The security mode may further include a second non-password mode in which the mobile device does not require a password but require a second user identification process to unlock the mobile device to a normal mode. The second user identification process may include recognizing a second user face, scanning a second user fingerprint, detecting a second trusted place in which the mobile device is located, detecting a second trusted device with which the mobile device communicates, detecting a second on-body according to a second state of the movement of the mobile device, etc.

As described above, the first non-password mode may be usable together with the first time condition. The second non-password mode may be usable with a second time condition. A first period of time as the first time condition may be different from a second period of time as the second time condition. The first period of time may be set as 4 hours, and the second period of time may be set 30 minutes or 2 hours. The present inventive concept is not limited to 30 minutes, 2 hours, or 4 hours. It is possible that the first and second time conditions may be a day or more. The first period of time may be fixed, and the second period of time may be changeable by a user. The first period of time and the second period of time may be variable according to a user preference. The second period of time may be shorter than the first period of time. The second period of time may not be longer than the first period of time. It is possible that the second period of time may be same as the first period of time.

The second user face may be a portion of the user face and/or a trusted person's face. When a user wears a mask or a sunglass, the portion of the user face may be an image of the user with the mask or the sunglass. The second user fingerprint may be a portion of the user fingerprint and/or a trusted person's fingerprint.

When the second user face is set, a user image with the mask or sunglass is photographed. The user image may be a user face with the mask or sunglass or a user face with clothes or shirts or no clothes, as the second user face.

A first user face may be set together with a first time condition, and a second user face may be set together with a second time condition. The first time condition may be a period of time from a most recent locking state locked from a most recent unlock state or a period of time from a time when the first user identification process of the first non-password mode with the first user face is set. The second time condition may be a period of time from a most recent locking state locked from a most recent unlock state or a period of time from a time when the second user identification process of the second non-password mode with the second user face is set.

The second trusted place may be an enlarged area of the trusted place and/or an adjacent area of the trusted place. The second trusted place may be detected according to a photographed image taken by a camera. The second trusted place may be detected by activating a user-selected camera to photograph an object around the mobile device, and by determining an authorized user or a user identity according to a state of the photographed image.

When the second trusted place is set, an address may be displayed as a location of the mobile device or a circle on a map may be displayed as a location of the mobile device. The address may be displayed with at least one adjacent address. The at least one adjacent address may be selected as the second trusted place. The circle may be enlarged on a map by a user as the second trusted place.

A first trusted place may be set together with a first time condition, and a second trusted place may be set together with a second time condition. The first time condition may be a period of time from a most recent locking state locked from a most recent unlock state or a period of time from a time when the first user identification process of the first non-password mode with the first trusted place is set. The second time condition may be a period of time from a most recent locking state locked from a most recent unlock state or a period of time from a time when the second user identification process of the second non-password mode with the second trusted place is set.

The second trusted device may be a portion of data of the trusted device or another trusted device. The first trusted device may be a full of data of the trusted device or another trusted device. The second trusted device may be an image of the trusted device which is taken by a camera. The second trusted device may be detected by activating a user-selected camera to photograph an object together with or around the trusted device, and by determining an authorized user or a user identity according to a state of the photographed image.

A first trusted device may be set together with a first time condition, and a second trusted device may be set together with a second time condition. The first time condition may be a period of time from a most recent locking state locked from a most recent unlock state or a period of time from a time when the first user identification process of the first non-password mode with the first trusted device is set. The second time condition may be a period of time from a most recent locking state locked from a most recent unlock state or a period of time from a time when the second user identification process of the second non-password mode with the second trusted device is set,

The second on-body may be a portion of a movement of the mobile device or a certain movement of the mobile device. The on-body may be detected by a first state of a movement, and the second on-body may be detected by a second state of a movement of the mobile device. The on-body may be detected according to a first type of a movement of the mobile device, and the second on-body may be detected according to a second type of a movement of the mobile device. The second on-body may be a combination of a portion of a movement of the mobile device and another movement of the mobile device. The second state of the movement of the mobile device may be a non-continuation of the movement or a combination of a movement and a non-movement of the mobile device. The first on-body and the second on-body may be detected according to a state of a photographed image taken by a camera. The on-body and the second on-body may be detected by activating a user-selected camera (for example, a back camera or a front camera) to photograph an object around the mobile device, and by determining the authorized user or user identity according to a state of the photographed object. The state of the photographed may represent a movement of the mobile device.

A first on-body may be set together with a first time condition, and a second on-body may be set together with a second time condition. The first time condition may be a period of time from a most recent locking state locked from a most recent unlock state or a period of time from a time when the first user identification process of the first non-password mode with the first on-body is set. The second time condition may be a period of time from a most recent locking state locked from a most recent unlock state or a period of time from a time when the second user identification process of the second non-password mode with the second on-body is set.

When the second time condition is expired, the mobile device is changed from an unlock state to a lock state. When the second time condition is expired, the mobile device is changed from a normal mode of the unlock state to a power saving mode of the lock state. When the mobile device is locked by expiation of the second time condition, The mobile device may be unlocked by the first non-password mode or the password input mode in the security mode.

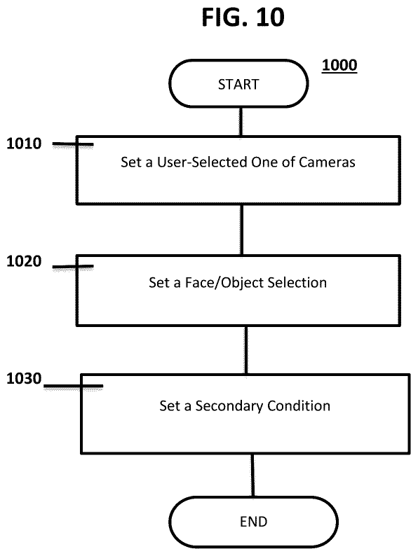

As illustrated in a method 1100 of FIG. 11, a first non-password mode 1110 may be set according to at least one of a first face recognition, a first fingerprint, a first trusted place, a first trusted device, a first on-body, etc. A second non-password mode 1120 may be set according to at least one of a second face recognition, a second fingerprint, a second trusted place, a second trusted device, a second on-body, etc. A user-selected camera may be set together with the first non-password mode 1110 and the second non-password mode 1120.

The first non-password mode 1110 may be usable without setting the second non-password mode 1120. The second non-password mode 1120 may be usable without setting the first non-password mode 1110.

The mobile device may be unlocked or a user identity may be verified, according to the first non-password mode The mobile device may be unlocked or a user identity may be verified, according to the second non-password mode when the first non-password mode is not available. The mobile device may be unlocked or a user identity may be verified, according to the second non-password mode as an extension of the first non-password mode. The mobile device may be unlocked or a user identity may be verified, according to a combination of the first non-password mode and the second non-password mode.

The second user identification process may be set as a combination of at least two of the second user face, the second trusted place, the second trusted device, and the trusted on-body. The combination may be set with a third time condition.

When the third time condition is expired, the mobile device is changed from an unlock state to a lock state. When the third time condition is expired, the mobile device is changed from a normal mode of the unlock state to a power saving mode of the lock state. When the mobile device is locked by expiation of the second time condition, the mobile device may be unlocked by the first non-password mode or the password input mode in the security mode.

When a user verification process is required in an application of the mobile device, the password input mode or the first non-password mode may be used as the user verification process. It is possible that the second non-password mode may be used as the user verification process.

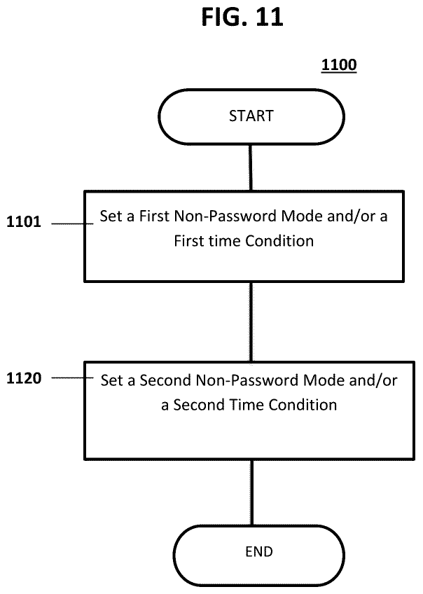

FIG. 12 is a flowchart illustrating a method 1200 of a mobile device according to an embodiment of the present inventive concept. The method 1200 may include an operation 1210 of unlocking the mobile device according to a password input mode when a password has been set without a non-password mode or when a user identification process fails to identify an authorized user, an operation 1220 of unlocking the mobile device according to a first non-password mode when the first non-password mode has been set, and an operation 1230 of unlocking the mobile device according to a second non-password mode when the second non-password mode has been set.

It is possible that operation 1210 may be performed as a user verification in an application of the mobile device when a password has been set without a non-password mode, that operation 1220 may be performed as a user verification in an application of the mobile device when the first non-password mode has been set, and that operation 1230 may be performed aa a user verification in an application of the mobile device when the second non-password mode has been set. However, the present inventive concept is not limited thereto. The first non-password mode and/or the second non-password mode may be usable to unlock the mobile device. The second non-password mode may be usable to unlock the mobile device, maintain the unlocked mobile device, and lock the unlocked mobile device.

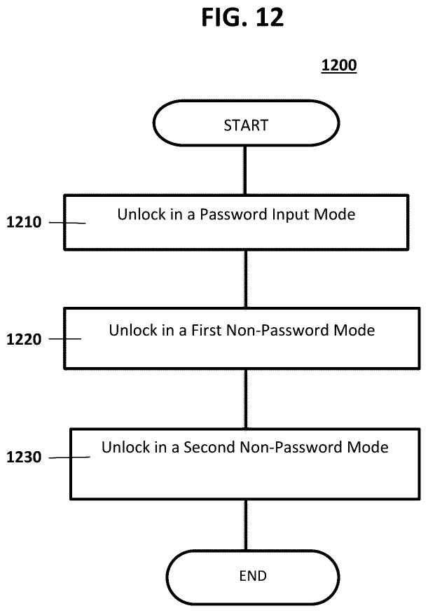

FIGS. 13A through 13C are diagrams illustrating second user faces according to embodiments of the present inventive concept. A first user face may be a face without covering a portion of a user face. The second user faces may be taken by a camera during setting the second user face. FIG. 13A illustrates a user image with a user sunglass, FIG. 13B is a user image with a face mask. FIG. 13C illustrates a user image with the face mask and sunglass. The mask may be a ski-mask. The second user faces may be different from a first user face. A user image of a second user face for a second non-password mode may have a priority portion different from a priority portion of a first user face for a first non-password mode. The user image of the second user face may have an option different from an eye-opening option or an eye-glasses. The user image of the second user face may include a shape of a user face, a ratio of a user face, a forehead, eyebrow, etc. The user image of the second user face may include at least a portion of clothes and a portion of an upper body.

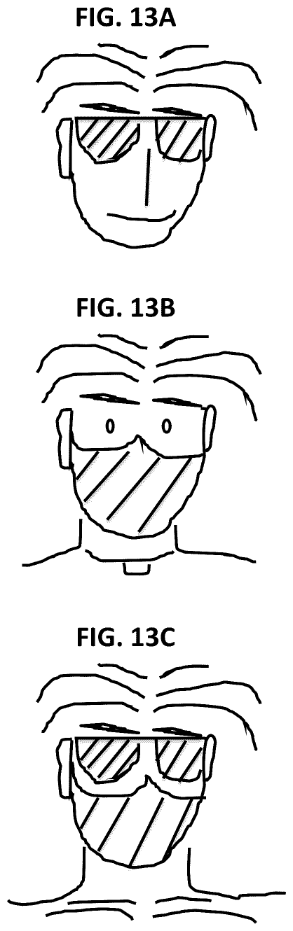

FIGS. 14A through 14C are diagrams illustrating second trusted places according to embodiments of the present inventive concept. A first trusted place is a first user identification process with a main address to unlock the mobile device. The first trusted place may cover the main address as a main location/place. The first trusted place may not cover an adjacent address. the second trusted place may be a second user identification process. The second trusted place may be an area covering the main address and adjacent address as an expanded location/place. FIG. 14A illustrates an address map with street numbers, for example, 1598, 1600, 1602, a street, 1599, 1601, 1603, etc. A street number 1600 may be a main address for a first trusted place. Another street number 1602 may be an address adjacent to the main address 1600, as the second trusted place. The mobile device may be set with the adjacent address and/or the main address as the second trusted place in response to a user selection. As illustrated in FIG. 14B, when the address map is displayed with a circle (solid line or dotted line) representing a main location/place as the trusted place on a panel of the mobile device during setting the second trusted place, a user may touch a touch panel of the panel of the mobile device to expand the circle (dotted line) of FIG. 14B. The mobile device is set with the expanded circle (solid line) including the circle (dotted line), as illustrated in FIG. 14C, as the second trusted place. The circle of the FIG. 14B may be changed to the expanded circle of FIG. 14C The mobile device may recognize a location or address of a map when the mobile device communicates with a wireless device through an internet connection. When the second trusted place is set, the mobile device may recognize the main address/place and also the adjacent address or the expanded place. The mobile device may be unlocked according to the first non-password mode with the main address/place and/or the second non-password mode with the second trusted address/place. The mobile device may be unlocked according to the first non-password mode with the main address/place and a first time condition and/or the second non-password mode with the second trusted address/place and a second time condition.

As illustrated above, a mobile device can be set in a security mode and the security mode can be set with a password input mode or a non-password mode. The non-password mode may be set with a first non-password mode and/or a second non-password mode. The non-password mode may be set with my face, other face, and object which may be combined with a selected camera and/or a secondary condition to perform a function of the mobile device, without the password. The second non-password mode may be set with a second user face, a second user fingerprint, a second trusted place, a second trusted device, a second on-body, etc.

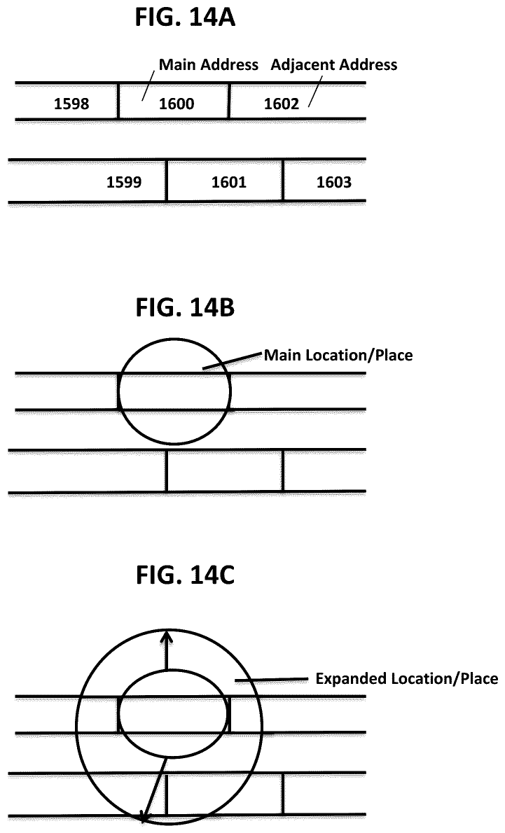

FIGS. 15A, 15B, and 15C are block diagrams illustrating a mobile device 1500 (1500A, 1500B, or 1500C) to selectively perform a public mode and a private mode with selective security mode in the mobile device 100 according to an embodiment of the present inventive concept.

The electronic terminal may be a computer apparatus, a portable personal computer, a mobile device, a mobile electronic device, a mobile phone, a smartphone, a mobile tablet apparatus, a mobile tablet computing apparatus, an audio or video recording and/or reproducing apparatus, a photographing apparatus, a communication device, etc. Hereinafter, various electronic terminals may be referred to as a mobile device.

The electronic terminal may communicate with a wireless external device. The electronic terminal may communicate with a wired external device. The electronic terminal may transmit and receive data to and from an external device through Internet. The electronic terminal may transmit and receive data to and from an external device through Bluetooth, WiFi, and mobile carrier standards.

The external device may be a wireless device connected to a wired Internet service provider for data communication, an access point (AP) such as a wireless access point device to connect to a wired network using WiFi, WiFi direct, or related standards, a device such as a Bluetooth device or radio frequency identification (RFID) device, etc., and a wireless station for wireless communication such as a mobile carrier service station for 5G, 4G, LTE, etc., and a wired station for wired communication such as in internet provider or various communication services. However, the present general inventive concept is not limited thereto. It is possible that the external apparatus may be another electronic apparatus. It is also possible that the external apparatus may be an apparatus to communicate with the electronic terminal to transmit and receive data therebetween. The external device may be a home appliance, such as a refrigerator, TV, or air conditioner. The external device may be a vehicle or a medical device. The external device may be a watch. The external device may be an extension device to extend a communication range of the external device.

The user of the mobile device 1500 may be allowed to set the one or more menus to be included in the public mode. The mobile device 1500 may include a screen including a state section (or non-user input menu section) and a user input menu section (or user input section or user menu section). The user of the mobile device 1500 may be allowed to set a portion of functions of each menu to be performed in the public mode. The user of the mobile device 1500 may be allowed to remove the menu from the pubic mode. The user of the mobile device 1500 may disable the menu of the public mode. The user of the mobile device may set the menu of the public mode to a limited access or non-access to a user data or to provide data stored in the mobile device. The one or more menus of the public mode are displayed in a user input section in which the user sets a menu to be included in the public mode, selects the menu of the public menu, and controls the operation of the menu during the public mode. The one or more menus of the public mode include one or more applications, one or more links of web pages, and one or more software or hardware of the mobile device 1500. The one or more menus of the public mode may include a voice control menu in which the user inputs a command to a voice unit of the mobile device 1500 and in which the unit of the mobile device 1500 outputs a reply to the user in response to the user voice, by using an internal data of the mobile device 1500 or by an external data through a connection with an external device. It is possible that scopes of the data usage and the external device connection may be set by the user or may be restricted to public data which is not a user data or a private data.

The menu of the public mode may include a sub-menu for an unlocking process to unlock the mobile device 1500 to change the public mode to the private mode. The menu of public mode may include a user menu to allow access to a user data or a private data. The unlocking process may include a password input method, a fingerprint method, a face recognition method, a trusted device method, a trusted place method. The unlocking process may be not limited thereto. The unlocking process may be a combination of various unlocking processes which will be described later. The mobile device 1500 may control a panel to display the sub-menu or the user menu such that the user is able to select the unlocking process during an operation of the menu in the public mode.

Referring to FIG. 15A, the mobile device 1500 (1500A) may include a switch 1501, and a screen 1510, and a camera 1511. The switch 1501 may be usable to turn on the mobile device 1500. The switch 1501 may be usable to change the mobile device 1500 from a power saving mode to a normal mode. The switch 1501 may be usable to activate an unlocking process to unlock the mobile device 100 to the normal mode during a power saving mode. The switch 1501 may be usable to change the power saving mode to a normal mode. The switch 1501 may be a sensor to sense a motion of the mobile device to perform a function of the switch to activate the mobile device, activate a user identification process or to change the mobile device from the power saving mode to the normal mode. The normal mode may be usable by a user of the mobile device 1500. The user of the mobile device 1500 may use all of menus, applications, and functions of the mobile device 1500 without restriction during usage of the mobile device 1500. The normal mode may be a combination of a public mode and a private mode. The switch 1501 may be usable to change the mobile device from the power saving mode to the public mode. The switch 1501 may be usable to change the public mode to the private mode. The switch 1501 may be usable to perform an unlocking process to unlock the mobile device 1500. The switch 1501 may be a button to be touched or pressed by a user to activate the mobile device 1500. The switch 1501 may be a sensor to sense a motion of the mobile device 1500 or a user image of the mobile device 1500 to activate the mobile device 1500. The switch 1501 may be a camera to photograph a user to activate an unlocking process of the mobile device 1500. The switch 1501 may be a voice recognition unit to recognize a user voice to activate the mobile device 1500. The switch 1501 may be a program to perform a user recognition process to recognize an authorized user of the mobile device 1500. The switch 1501 may be an interface to recognize an authorized user of the mobile device 1500. The switch 1501 may be an interface to communicate with an external device to identify the external device as an authorized user of the mobile device 1500. The present inventive concept is not limited thereto. The switch 1501 may be an input receiver to receive a user input to the mobile device 1500. The user input may be a password input, an image input, or a touch input. The present inventive concept is not limited thereto. The user input may be a signal from a user device.

The camera 1511 may be a photographing unit to photograph a user. The camera 1511 may be a sensor to sense a user image to determine an authorized user of the mobile device 1500.

The screen 1510 may be in a dark condition representing a power saving mode, a turnoff mode, or a deactivation mode. The screen 1510 may not display a menu or image on a panel of the mobile device 1500. The screen 1501 may be included in the panel to display the menu or image. The screen may be referred to as the panel. The panel may include a display film layer to display an image and menu and a touch film layer to receive a user touch input. The camera 1511 of the mobile device 1500 may photograph a user to receive a touchless user input to correspond to an image or menu displayed on the panel. When a user places a user finger over the corresponding image or menu, the camera 1511 photographs the user finger to determine a user touchless input. The mobile device 1500 may receive a user touch input and/or a user touchless input to perform a function of the mobile device 100. The mobile device 1500 may have a priority on one of the user touch inputs and the user touchless input. The mobile device 1500 may perform a function of the menu in response to the user touch input or the user touchless input.

Referring to FIG. 15B, the mobile device 1500 (1500B) include a switch 1501, a public screen 1520, one or more public mode menu icons 1525, a camera 1521, a state section 1522, a user menu section 1523. The switch 1501 and the camera 1521 of FIG. 1500B may be same or similar to the switch 1501 and the camera 1511 of FIG. 1500A, respectively.

The display panel of the mobile device 1500 may display the public screen 1520 with one or more public mode menu icons 1525. The one or more public mode menu icons 1525 may include one or more applications or one or more links of web pages, and/or one or more function menus of the mobile device 1500. The one or more applications are downloaded from an application store. The one or more links of web pages are added to a home screen of the mobile device 100. The one or more function menus correspond to respective hardware or software installed in the mobile device 1500. The user of the mobile device 1500 may set the one or more public mode menu icons 1525 to be usable in the public mode. The user of the mobile device 1500 may set a portion of a menu to be available in the public mode as the public mode menu icon 1525 and may set the other portion of the menu icon to be available in the private mode in a private mode menu icon. The public mode menu icon 1525 and the private mode menu icon may be same or may be different color or shape such that the user can recognize the icons in the public mode and the private mode.

The user may be required to enter a password or an unlock process to change the public mode to the private mode. The public mode may not allow access to private data which is defined by the user to the corresponding menu.

For example, the public mode menu icon 1525 is selected by the user, the mobile device 1500 may perform an operation of the corresponding menu to output data (image or audio) which is available to public only, and may not perform an operation of the corresponding menu to output data (image or audio) which is not available in public but available to the user of the mobile device 1500. As an example, the public mode menu icon 1525 is a map, the map is displayed on the panel data available to public and may not be displayed on the panel data available to the user of the mobile device 1500. When the user requests the mobile device 1500 through a user input or user voice, the mobile device 1500 outputs data available to the public in response to the user input or user voice. Here, the mobile device 100 may have a function to recognize a user voice and also a function to access data or retrieve data available to the public. The user may set which data is in the public mode and the private mode in the mobile device 1500.

The state section 1522 includes one or more non-user input menus, such as a time display, a state of Bluetooth connection, a state of WiFi connection, a state of mobile data connection, and a state of a battery. The user may not change a location of the non-user input menu. The user may not change a status of the non-user input menu since the mobile device 100 performs an operation of the non-user input menu as a background operation. The non-user input menu may not receive a user input. The user menu section 1523 includes one or more menus such that the user may selects at least one of the one or more menus to control the mobile device 100 to perform an operation of the menu. The user may change a location of the user input menu with respect to the screen 1520.

Referring to FIG. 15C, the mobile device 1500 (1500C) includes include a switch 1501, a private screen 1530, one or more public mode menu icons 1535, a camera 1531, a state section 1532, a user menu section 1533. The switch 1501 and the camera 1531 of FIG. 15C may be same or similar to the switch 1521 and camera 1521 of FIG. 15B.

The display panel of the mobile device 1500 may display the private screen 1530 with one or more private mode menu icons 1535. The one or more private mode menu icons 1535 may include one or more applications, one or more links of web pages, and/or one or more function menus of the mobile device 1500. The one or more private mode menu icons 1535 may be same as a normal mode of a mobile device which has a full operation mode of all menus of the mobile device when the mobile device is unlocked. The one or more private mode menu icons 1535 include one or more applications, one or more links of web pages, and/or one or more function menus of the mobile device 1500. The applications are downloaded from an application store. The links of web pages are added to a home screen of the mobile device 1500. The function menus correspond to respective hardware or software installed in the mobile device 1500. The user of the mobile device 100 may set the menus to be one or more public mode menu icons 1525 usable in the public mode and to be one or more private mode menu icons 1535 usable in the private mode. The user of the mobile device 1500 may set a portion of a menu to be available in the public mode as the public mode menu icon 1525 and may set the other portion of the menu icon to be available in the private mode in the private mode menu icon 1535. The public mode menu icon 1525 and the private mode menu icon 1535 may be same or may be different in color or shape, such that the user can recognize the icons in the public mode and the private mode. The user of the mobile device 1500 may set a menu as a private mode only.

The mobile device 1500 may have a first number of menus for the public mode and a second number of menus for the private mode. A menu of the private mode may not be in the public mode. A menu of the private mode may be displayed in the public mode.

The user may be required to enter a password or an unlock process to change the public mode to the private mode. The private mode may access all data of the mobile device 100.

For example, the private mode menu icon 1535 is selected by the user, the mobile device 1500 may perform an operation of the corresponding menu to output data (image or audio) of the mobile device.

The state section 1532 includes one or more non-user input menus, such as a time display, a state of Bluetooth connection, a state of WiFi connection, a state of mobile data connection, and a state of a battery. The user may not change a location of the non-user input menu. The user may not change a status of the non-user input menu since the mobile device 100 performs an operation of the non-user input menu as a background operation. The non-user input menu may not receive a user input. The user menu section 1533 includes one or more menus such that the user may selects at least one of the one or more menus to control the mobile device 1500 to perform an operation of the menu. The user may change a location of the user input menu.

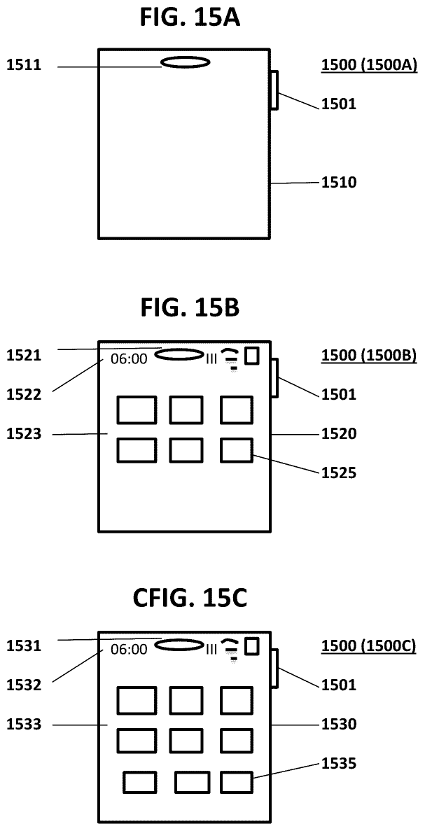

FIGS. 16A, 16B, 16C, and 16D are diagrams illustrating a mobile device 1600 (1600A, 1600B, 1600C, and 1600D) to set an unlock method and to be unlocked by the set unlock method according to an embodiment of the present inventive concept.

Referring to FIG. 16A, the mobile device 1600 (1600A) includes a screen 1610, a switch 1611, a camera 1612. The mobile device 1600 controls a display panel to display the screen 1610 with a password input menu 1613 to set a password or to receive the set password through a touch panel for the unlocking process. The password may be received through touchless user input.

When the mobile device 1600 is not set with a password, a user can access all menus of the mobile device 1600. In this case, the mobile device 1600 may not have a public mode. It is possible that the mobile device 1600 may have a public mode and a private mode. The public mode may be changed to the private mode without the unlocking process.

When the mobile device 1600 is set with a password, a user may access the public mode in response to an operation of the switch 311 without the password. The user may access the private mode with the password of the unlocking process during a selection of the public mode menu or an operation of the public mode menu.

Referring to FIG. 16B, the mobile device 1600 (1600B) includes a screen 1620, a switch 1621, a camera 1622. The unlocking process is a user interaction process such as a face recognition method 1623 by using the camera 1622 and/or a voice recognition method 1624 by using a voice control (not shown) or an audio unit which is installed as a program inside the mobile device 1600. The mobile device 16300 may control a display panel to display a symbol corresponding to a user interaction process, such as a face recognition method and the voice recognition method. The user interaction process may be set to be usable to unlock the mobile device to the provide mode.

Referring to FIG. 16C, the mobile device 1600 (1600C) includes a screen 1630, a switch 1631, a camera 1632. The unlocking process is a user interaction process such as a face recognition method 1623 by using the camera 1622, a voice recognition method 1624 by using a voice control (not shown) which is installed as a program inside the mobile device 300, and/or a motion detection method by using a sensor (not shown) installed inside the mobile device 1600 to detect a motion of the mobile device 1600. The mobile device 300 may have an option to set the user interaction process as the unlocking process. The mobile device 1600 may control a display panel to display a symbol corresponding to a user interaction process, such as a face recognition method, the voice recognition method, and the motion detection method. The user interaction process may be set to be usable to unlock the mobile device 1600 to the private mode.

When a time condition is set in the mobile device 1600, the mobile device 1600 may be unlocked by using the user interaction process in the time condition. The mobile device 1600 may not be unlocked by the user interaction process when the mobile device is not in the time condition. The mobile device 1600 may be unlocked by using the password when the mobile device 1600 is not in the time condition. The time condition may be a period of time, and may be several minutes or several hours, for example, from the last unlock state or from the start of the public mode.

Referring to FIG. 16D, the mobile device 1600 (1600D) includes a screen 1640, a switch 1641, a camera 1642. The unlocking process may be an external communication method 1643 in which the mobile device 300 communicates with an external device or network and in which the mobile device 300 recognizes that the communication with the external device or network is an authorized user to access the private mode. The external communication method 1643 may be set as a trusted device or a trusted place as the unlocking process. The mobile device 1600 controls a display panel to display a menu for the external communication method.

The password input method, the user interaction method, and the external communication may be usable as the unlocking process. It is possible that a combination of the password input method, the user interaction method, and the external communication may be usable as the unlocking process. It is possible that a combination of the user interaction method and the external communication may be usable as the unlocking process. It is possible that a combination of a level of the user interaction method and a level of the external communication may be usable as the unlocking process.

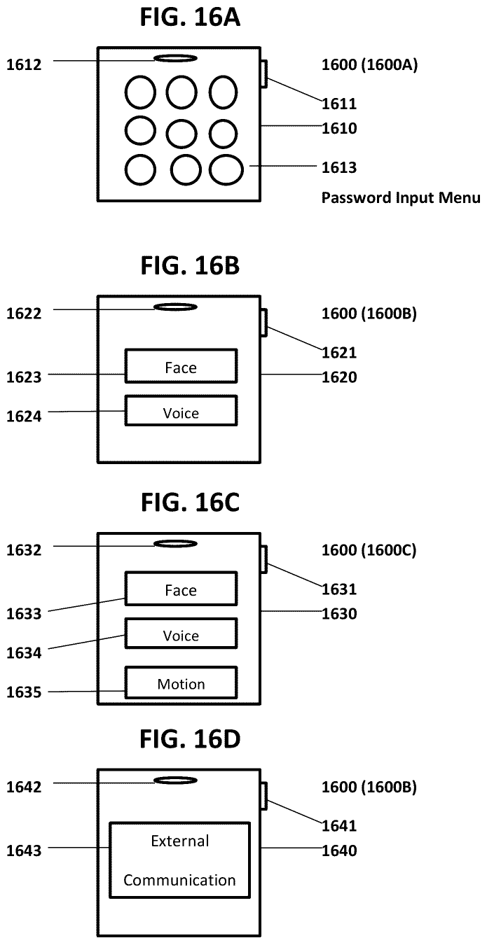

FIG. 17 is a diagram illustrating a method of setting a menu to a public mode and/or a private mode in a mobile device 1700 according to an embodiment of the present inventive concept. The mobile device 1700 may include a screen 1701 with a setting menu 1720 to set a menu 1710 of an application, a link of web page, and a function menu into a public mode 1730 and a private mode 1740. When the menu 1710 is set to the private mode 1740 only, the menu is not included in the public mode. When the menu 410 is set to the public mode 430 and the private mode 1740, the menu 1710 is included in the public mode and the private mode. The menu 1710 of the public mode 430 may be different from the menu 1710 of the private mode 1740 in shape or color. The menu 1710 of the public mode 1730 may be different from the menu 1710 of the private mode 1740 in accessibility of a user data or a private data of the mobile device 1700.

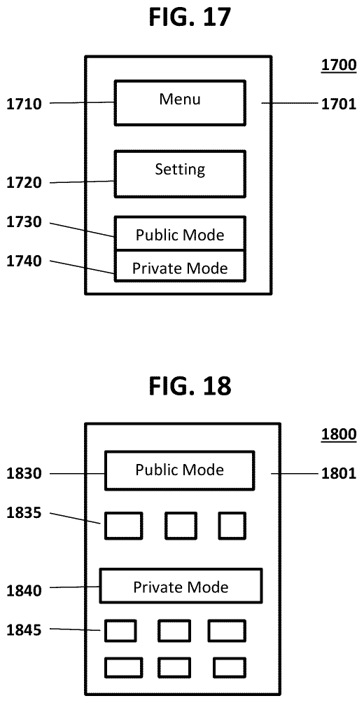

FIG. 18 is a diagram illustrating a method of setting menus to a public mode and a private mode in a mobile device 1800 according to an embodiment of the present inventive concept. The mobile device 1800 may include a screen 1801 with a setting menu to set one or more menus 1835 to be included in a public mode 1830 and one or more menus 1845 to be included in a private mode. The menus may be an application, a link of web page, and a function menu. Each of menus may be located in one of the public mode 1830 and the private mode 1840 or may be located in both of the public mode 530 and the private mode 1840.

The menus may be dragged from the public mode 1830 to the private mode 1840 or from the private mode 1840 to the public mode 1830. The menus may be duplicated to be included both the public mode 530 and the private mode 1840.

The menus 1835 of the public mode 530 may be different from the menus 1845 of the private mode 1840 in shaper or color. The menu 410 of the public mode 1830 may be different from the menu 1810 of the private mode 440 in accessibility of a user data or a private data of the mobile device 1800.

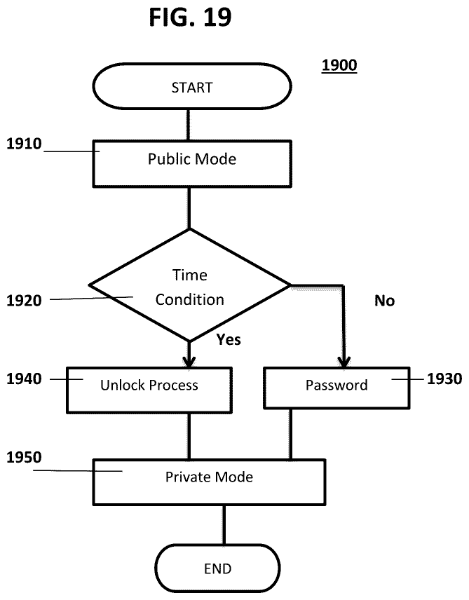

FIG. 19 is a flowchart illustrating a method 1900 of selectively applying a public mode and a private mode in a mobile device according to an embodiment of the present inventive concept. The method 1900 performs a public mode operation 1910 to display menus in a public mode in response to an operation of a switch, a time condition operation 1920 to determine whether the mobile device is in a time condition, a password input operation 1930 to receive a password when the mobile device is not in the time condition in the operation 1920, an unlocking process operation 1950 to perform a face recognition, a voice recognition, a motion detection, and/or an external communication when the mobile device is in the time condition, and a private mode operation 1950 when the password is received or when the unlocking process is successfully performed. The time condition operation may not be included in the method 1900. The unlocking process may be referred to as a non-password input process to unlock the mobile device.

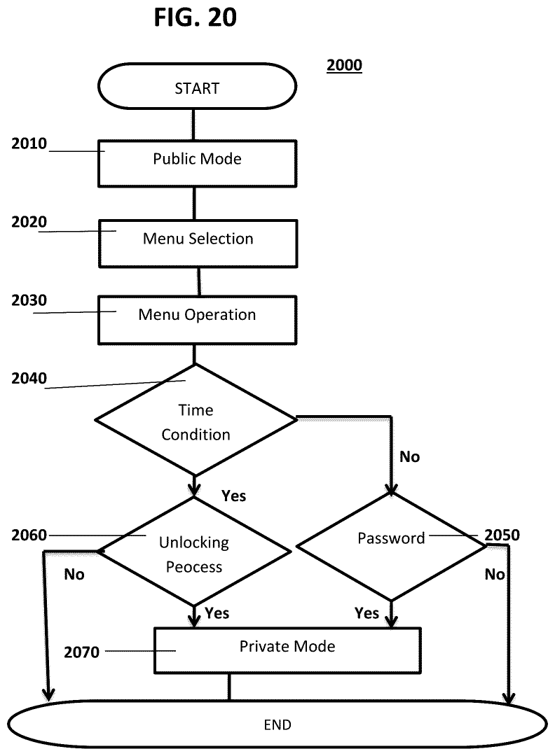

FIG. 20 is a flowchart illustrating a method 2000 of selectively applying a public mode and a private mode in a mobile device according to an embodiment of the present inventive concept. The method includes a public mode operation 2010 in response to an operation of a switch, a menu selection operation 2020 in which a user selects a menu of the public mode, a menu operation 2030 to perform the selected menu, a condition operation 2040 to determine whether the mobile device is in a condition, a password input operation 2050 to receive a password when the mobile device is not in the condition, an unlocking process 2060 to perform a face recognition, a voice recognition, a motion detection, and/or an external communication when the mobile device is in the time condition, and a private mode operation 2050 when the password is received or when the unlocking process is successfully performed. The condition operation may not be included in the method 2000. The condition may be a time condition or a environment condition such as brightness, quietness, etc. The unlocking process may be referred to as a non-password input process to unlock the mobile device.

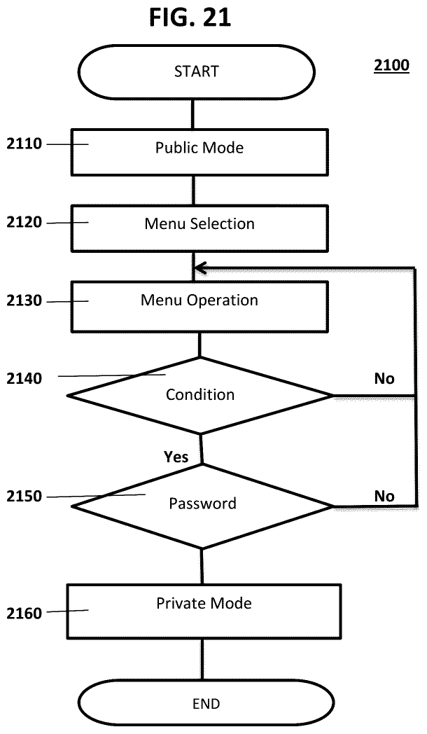

FIG. 21 is a flowchart illustrating a method 2100 of selectively applying a public mode and a private mode in a mobile device according to an embodiment of the present inventive concept. The method 2100 may include a public mode operation 2110 to perform a public mode in response to an operation of a switch, a menu selection operation 2120 to select a menu of the public mode, a menu operation 2130 to perform the selected menu, a condition operation 2140 to determine whether the menu requires access to a user data or a private data, a password input operation 2150 to receive a password to allow the user to access the user face or private data, that is, unlock the mobile device to a private mode, and a private mode operation to perform a private mode. The password input operation 2150 may include a face recognition, a voice recognition, a motion detection, and/or an external communication. The method 2100 may perform a private mode in operation 2160.

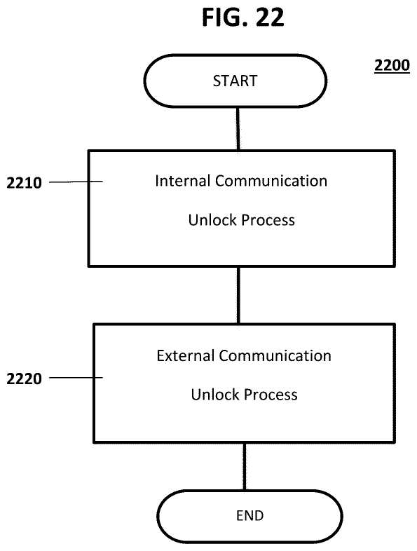

FIG. 22 is a flowchart illustrating a method 2200 of setting and applying an unlock process as a user identification process for a private mode of a mobile device according to an embodiment of the present inventive concept. The method 2200 includes a user internal communication unlock process 2210 and an external communication unlock process 2220. The user internal communication unlock process may an internal process between a user and the mobile device which includes a face recognition, a voice recognition, and a motion detection. The external communication unlock process may be an external process between the mobile device and an external device, which includes a trusted device and a trusted place. An environment condition or a time condition may be included in the user internal communication unlock process 2210 and the external communication unlock process 2220. When the mobile device is not in the environment condition or the time condition, a password is required to unlock the mobile device to the private mode. The mobile device is set to perform the internal communication unlock process 2210 and/or the external communication unlock process 2220 as a user identification process to unlock the mobile device. The mobile device may selectively perform at least one of the internal communication unlock process 2210 and the external communication unlock process 2220 as a user identification process to unlock the mobile device according to an activity or a condition detected by the mobile device.

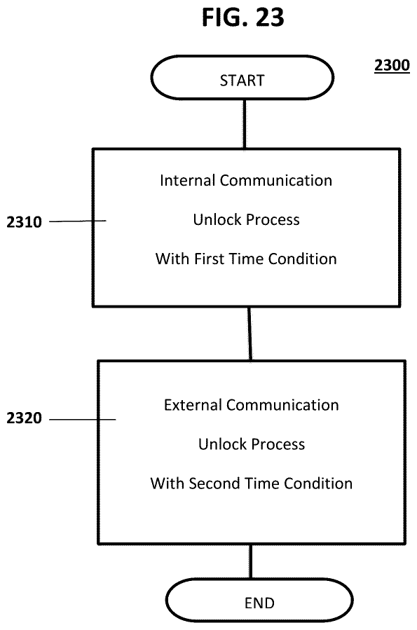

FIG. 23 is a flowchart illustrating a method 2300 of setting and applying unlocking processes with time conditions as a user identification process to a menu of a private mode of a mobile device according to an embodiment of the present inventive concept. The method 2300 may include a user communication unlock process 2310 with a first time condition and an external communication unlock process 2320 with a second time condition. When the mobile device is in the first time condition, the mobile device performs the private mode by the user communication unlock process when being in the first time condition. When the mobile device Is not in the second time condition, the mobile device performs the private mode by the external communication unlock process 2320 when being in the second time condition. When the mobile device is not in the first time condition and the second time condition, the mobile device may perform the private mode by a password input. The first time and the second time may be different from each other. The first time and the second time may be same. The first time condition is one hour when the second time condition is two hours. The first condition may be two hours when the second time condition is one hour. The first time condition and the second time may be variable according to a usage of the mobile device or according to a time period of the public mode. The first time condition and the second time condition is a period of time between an operation of the switch and the last unlock.

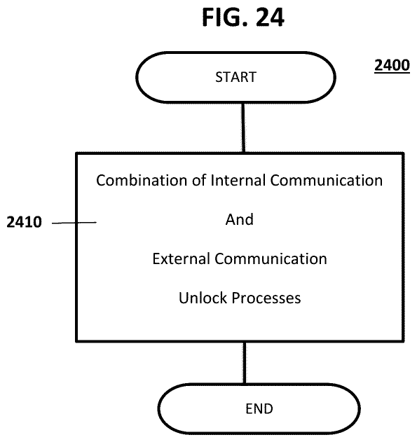

FIG. 24 is a flowchart illustrating a method 2400 of setting and applying a combination of unlocking processes as a user identification process in a mobile device. The method may apply various unlock processes to perform a menu of a private mode of a mobile device according to an embodiment of the present inventive concept. The method 2400 may include a combination operation 2410 to combine a user internal communication unlock process and an external communication unlock process as an unlock process to allow a user to access a private mode or to unlock the mobile device for a private mode.

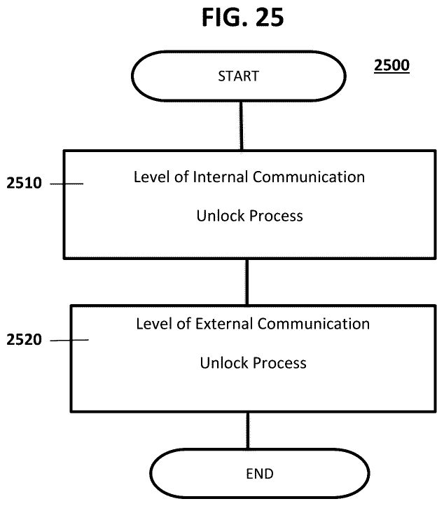

FIG. 25 is a flowchart illustrating a method 2500 off setting and applying levels of unlocking processes in a mobile device. The method 2500 may apply unlocking processes to a menu of a private mode of a mobile device according to an embodiment of the present inventive concept. The method 2500 includes a level setting operation to set a first level of unlock processes of a user internal communication unlock process and a second level of an external communication unlock process. The level of the user internal communication unlock process may be 80% of accuracy of a face recognition, a voice recognition, and a motion detection. The 80% of accuracy may be an 80% resolution of a photographed image of a user face in the face recognition, an 80% of similarity of a user voice in the voice recognition, and an 80% of a movement change of the mobile device in the motion detection. The 80% may be changed according to a user preference or a design preference. The level of the external communication may be 90% of accuracy of a trusted device or a trusted place. In the trusted device, 90% of a strong signal from an external device may be the trusted device. In the trusted place, an area which is 90% near the trusted place may be the trusted place. The 90% may be changed according to a user preference or a design preference. When the user internal communication unlock process and the external communication unlock process are combined to unlock the mobile device, 80% accuracy of the user communication unlock process and 90% accuracy of the external communication unlock process may be usable to unlock the mobile device.

In a case of a trusted place and a trusted device based on an external communication with an external device, the mobile device is unlocked according to a main address and also is unlocked according to an expanded area which is expanded from a main address area. When a WiFi as an external device is located in an address of a user house, the mobile device is unlocked according to the address of the user house (trusted place and the connection of the WiFi. The mobile device is unlocked according to the expanded area, the connection of the WiFi, and a strength of a signal received from the WiFi. The main address and the connection of the external device may be a first user identification process. The expanded area and the connection of the external device, and the strength of the signal may be a second user identification process.

As illustrated above, a mobile device can be set in a security mode and the security mode can be set with a safe zone so that a mobile device does not require a user to enter a password when a current condition matches a predetermined condition of the safe zone. The current condition may be a level of a signal detected from an external device or a level of coverage of a location/place to unlock the mobile device, to maintain the unlock mobile device, and to lock the unlocked mobile device.

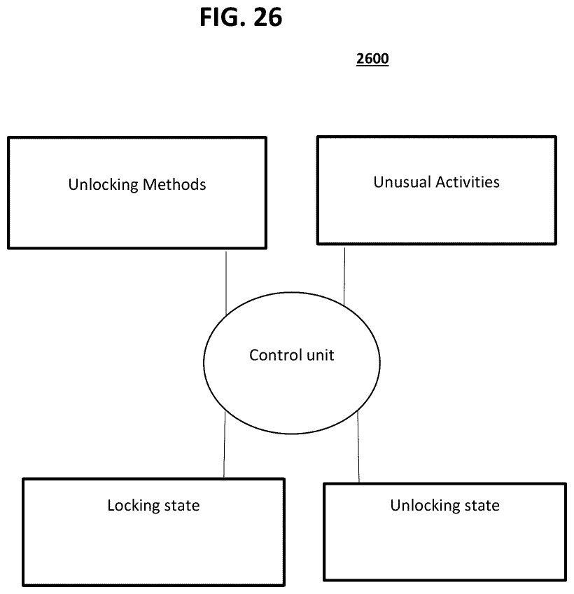

FIG. 26 is a diagram illustrating a mobile device 2600 to perform unlocking methods 2600 in a mobile device according to an embodiment of the present inventive concept.

The mobile device 2600 may be a computer apparatus, a portable personal computer, a mobile device, a mobile electronic device, a mobile phone, a smartphone, a mobile tablet apparatus, a mobile tablet computing apparatus, an audio or video recording and/or reproducing apparatus, a photographing apparatus, a communication device, etc. Hereinafter, various electronic terminals may be referred to as a mobile device.

The mobile device 2600 may include a control unit to control unlocking methods, unusual activity detections, a locking state, and an unlocking state.

The unlocking methods may be referred to as user identification processes and may include user identifications with a password, a face recognition, a fingerprint, a trusted place, a trusted device, an on-body detection, a portion of a user body, etc. The unlocking methods may be a combination of two or more of the password, face recognition, fingerprint, trusted place, trusted device, on-body detection, portion of a user body, and so on. The unlocking methods may include an internal communication unlock process and/or an external communication unlock process. The unlocking methods may include a primary unlocking method and a secondary unlocking method. The primary unlocking method may be same as the secondary unlocking method. It is possible that the primary unlocking method may be different from the secondary unlocking method. It is also possible that a level of the primary unlocking method is higher that a level of the secondary unlocking method. It is also possible that a level of the secondary unlocking method is higher than the primary unlocking method. The level may be referred to as a security level or an unlocking difficulty. For example, a level may be a resolution of a face recognition image or a signal intensity. For example, a password may be 6 digits or 8 digits.

The mobile device 2600 may include various sensors to perform the unlocking methods and the unusual activities. The unlocking methods may be usable during a power saving mode to unlock the mobile device to a normal mode. The unlocking methods may be a primary unlock method to unlock without the unusual activities.

The unusual activities may include a sound, an image, a movement, etc. The unusual activities may be a combination of the sound, image, movement, and so on. The mobile device 100 may include various sensors to detect the sound, the image, the movement, etc. The sound may be detected by an audio sensor, and then the control unit determines whether the sound is suspicious to indicate that a user is an unauthorized user. For example, the sound may be a voice of a person. The voice may be a threatening tone to unlock the mobile device. The voice may correspond to a hacking-related situation to unlock the mobile device. The unusual activities may include a signal detection of an external device. The unusual activities may include a condition of an external device. The unusual activities may include a strength or weakness of a signal received from an external device. The unusual activities may be higher or lower than a reference of 90% of a signal detected from an external device. However, the present inventive concept is not limited thereto. The signal strength or weakness may be different from 90%.

The image may be a user image photographed by a camera. The photographed image may be compared to an authorized user image. For example, an authorized user looks at a screen of the mobile device as soon as the mobile device is unlocked. When the image is not the authorized user image just after unlocking, a user may not be the authorized user or an unauthorized user may take the mobile device away from the authorized user.

The movement may be a movement of the mobile device. When the mobile device moves abruptly or unusually, the control unit may determine that the mobile device is prevented from being used by an unauthorized user according to the movement. For example, an authorized user looks at a screen of the mobile device as soon as the mobile device is unlocked. When an unusual movement is detected soon after unlocking, a user may not be the authorized user or an unauthorized user may take the mobile device away from the authorized user.

The unusual activities may include a situation in which a user selects a menu including a setting menu to change settings as soon as the mobile device is unlocked. The control unit may determine that the user may not be an authorized user.

The unusual activities may be detected before the unlock method, during the unlock method, and/or after the mobile device is unlocked by the unlock method.

The primary unlock method may be performed to unlock the mobile device when the unusual activity is not detected. When the unusual activity is detected, the secondary unlocking method is performed in response to the detected unusual activity.

The locking state may be a power saving mode or a power off mode, and the unlocking state may be a normal mode. The control unit locks or unlocks the mobile device according to the primary unlocking method and the secondary unlock method.

A mobile device may selectively perform a public mode and a private mode according to a condition set by a user when the mobile device receives a user input of a switch to change the mobile device to a normal mode or public-private mode, which includes a power-on and an activation mode, from a power saving mode which includes a power-off and a deactivation mode.

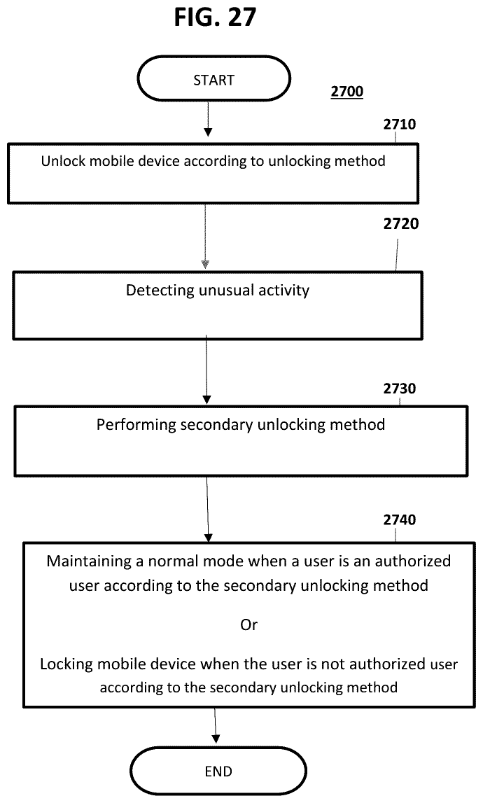

FIG. 27 is a diagram illustrating a method 2700 of a mobile device to detect an unusual activity and to perform a secondary unlocking method according to an embodiment of the present inventive concept

At operation 2710, the mobile device is unlocked according to an unlocking method.

At operation 2720, the mobile device detects an unusual activity after the unlocking method.

At operation 2730, the mobile device performs the secondary unlocking method in response to the detected unusual activity.

At operation 2740, the mobile device maintains a normal mode when a user is an authorized user according to the secondary unlocking method

Also, at operation 2740, the mobile device is locked when a user is not an authorized user according to the secondary unlocking method.

It is possible that the unusual activity is detected before or during the unlocking method. In this case, the mobile device may perform the primary unlocking method and/or the secondary unlocking method.

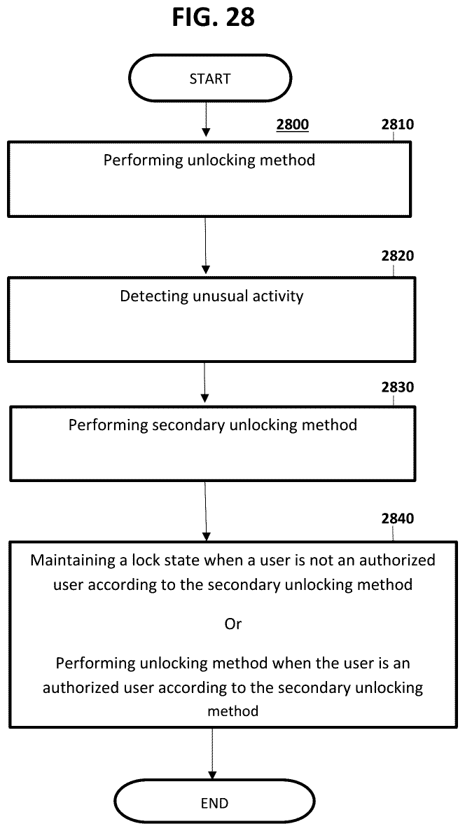

FIG. 28 is a diagram illustrating a method 2800 of a mobile device to detect an unusual activity during an unlocking method, and to perform a secondary unlocking method according to an embodiment of the present inventive concept

At operation 2810, the mobile device performs the unlocking method.

At operation 2820, the mobile device may detect an unusual activity during the unlocking method.

At operation 2830, the mobile device may perform the secondary unlocking method in response to the detected unusual activity.

At operation 2840, the mobile device maintains a lock state when a user is not an authorized user according to the secondary unlocking method, or performs the primary unlocking method and/or the secondary unlocking method, when the user is an authorized user according to the secondary unlocking method.

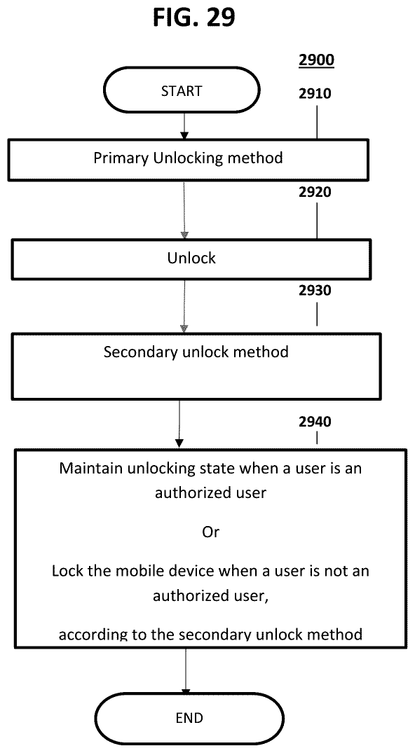

FIG. 29 is a flowchart illustrating a method 2900 of a mobile device to perform a primary unlocking method and secondary unlocking method a time period after unlock according to an embodiment of the present inventive concept.

At operation 2910, the mobile device performs the primary Unlocking method.

At operation 2920, the mobile device is unlocked according to the primary unlocking method.

At operation 2930, the mobile device performs the secondary unlock method after a period of time after being unlocked.

At operation 2930, it is possible that the mobile device detects the unusual activity.

At operation 2940, the mobile device maintains an unlocking state when a user is an authorized user according to the secondary unlocking method.

At operation 2940, the mobile device may be locked when a user is not an authorized user according to the secondary unlocking method.

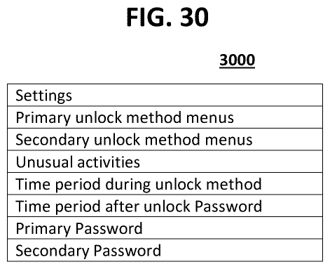

FIG. 30 is a diagram illustrating setting menus 3000 of a mobile device including according to the present inventive concept.

The setting menus 3000 may include primary unlock method menus, secondary unlock method menus, unusual activities before, during, and/or after unlocking of the mobile device, a time period during an unlock method, a time period after the mobile device is unlocked, a password including a primary password and a secondary password. A user may select at least one of the setting menus to set a condition of an unlocking method, an unusual activity, a time period to perform a secondary unlocking method before, during, and after performing the unlocking method, and a password.

The user may set up an unusual activity in which an unauthorized user attempts to unlock the mobile device. For example, a user may have a habit before, during, or after the unlocking method is performed, or before, during, or after the mobile device is unlocked. The user may set a non-habit as an unusual activity or may set the habit as a usual activity. When the mobile device detects the unusual activity, the mobile device performs the secondary unlocking method.

As described above, a mobile device is protected from an unauthorized user. The mobile device may prevent personal data from being stolen by an unauthorized user during the unlocking.

As illustrated above, a mobile device can be set in a security mode and the security mode can be set with a safe zone so that a mobile device does not require a user to enter a password when a current condition matches a predetermined condition of the safe zone.

As illustrated above, a mobile device may provide various options for a user to unlock the mobile device to a normal mode or one of a public mode and a private mode.

As described above, a security mode or a non-password security mode may include options to selectively apply an internal condition mode and an external condition mode as a user identification process to the security mode of the mobile device. The mobile device may perform different user identification processes according to the one or more options including activity conditions and/or signal conditions detected by sensors of the mobile device, to unlock the mobile device, to maintain an unlock state of the mobile device, and/or to lock the unlocked mobile device.

As illustrated above, a mobile device may be unlocked according to various unlocking methods and various activity detections according to an embodiment of the present inventive concept. In the face recognition mode, a user has to place a user face in front of a font camera of a mobile device. In the trusted place mode, a mobile device has to communicate with an external network to be in a trusted place. The face recognition mode may be a biometric recognition mode to determine an authorized user of a mobile device. The mobile device may provide different options to be applied to the security mode or the non-password security mode to determine an authorized user of the mobile device.

In the trusted place mode, a mobile device has to communicate with an external network to be in a trusted place. The mobile device may provide different options to be applied to the security mode or the non-password security mode to determine an authorized user of the mobile device.

One or more cameras of a mobile device may be set to perform a user identification process in the security mode. One or more images captured by one or more cameras may be usable in the user identification process in the security mode to determine an authorized user of the mobile device.

One or more options may be set to be applied to a user identification process in the security mode. The options may include one or more conditions to be applied to a user identification process in the security mode. The conditions may be one or more activities detected by the mobile device. The conditions may be a condition of an external device usable to unlock the mobile device. The conditions may be a strength or weakness of a signal received from the external device to apply different user identification process to the security mode to unlock the mobile device, to maintain an unlock state of the mobile device, or to lock the unlocked mobile device The options may include different user identification processes to be selectively applied to the security mode to unlock the mobile device, to maintain an unlock state of the mobile device, or to lock the unlocked mobile device.

As described above, a mobile device provides various options to be selectively applied to a security mode such that the mobile device is unlocked, the unlocked mobile device is maintained, and the unlocked mobile device is locked, according to one or more user identification processes and the various options.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a read-only memory (ROM), a random-access memory (RAM), a flash memory, a semiconductor chip package, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A non-transitory computer-readable medium containing computer-readable codes as a program to execute a method in a mobile device having a network interface, cameras and sensors, and a panel to display a menu and an image, the method comprising:
performing a first user identification process in a security mode by using a first user selection of the network interface, the cameras, and the sensors;
unlocking the mobile device according to the first user identification process;
performing a second user identification process by using a second user selection of the network interface, the cameras, and the sensors; and
maintaining an unlock state of the mobile device according to the second user identification process.

2. The medium of claim 1, further comprising:
locking the unlocked mobile device when the second user identification process fails.

3. The medium of claim 1, further comprising:
detecting an unusual activity by using at least one of the network interface, the cameras, and the sensors,
wherein the performing the second user identification process further comprises performing the second user identification process by using at least one of the network interface, the cameras in response to the detected unusual activity.

4. The medium of claim 3, wherein the unusual activity comprises at least one of a sound, an image, and a motion of the mobile device.

5. The medium of claim 1, further comprising:
detecting a condition by using the network interface, the cameras, and the sensors,
wherein the performing the second user identification process further comprises performing the second user identification process by using the network interface in response to the detected condition.

6. The medium of claim 1, wherein the first user identification process comprises a face recognition process, and the second user identification process comprises a trusted place.

7. The medium of claim 1, wherein the first user identification process comprises a trusted place, and the second user identification process comprises a face recognition process.

8. The medium of claim 1, wherein the first user identification process comprises a user body portion recognition process, and the second user identification process comprises a trusted place.

8. The medium of claim 1, wherein the first user identification process comprises a trusted place, and the second user identification process comprises a user body portion recognition process.

10. The medium of claim 1, wherein the first user identification process comprises an object recognition process, and the second user identification process comprises a trusted place.

11. The medium of claim 1, wherein the first user identification process comprises a trusted place, and the second user identification process comprises an object recognition process.

12. The medium of claim 1, wherein the first user identification process comprises a first level of a user identification process, and the second user identification process comprises a second level of the user identification process.

13. The medium of claim 1, wherein the first user identification process comprises a an internal communication process between the mobile device and a user, and the second user identification process comprises an external communication process between the mobile device and the external device.

14. The medium of claim 1, wherein the first user identification process comprises an external communication process between the mobile device and the external device, and the second user identification process comprises an internal communication process between the mobile device and a user.

15. The medium of claim 1, wherein the first user selection of the network interface, the cameras, and the sensors further comprises a user selection of at least one of the cameras.

16. The medium of claim 1, wherein the second user selection of the network interface, the cameras, and the sensors further comprises a user selection of at least one of the cameras.

16. The medium of claim 1, wherein the first user selection of the network interface, the cameras, and the sensors further comprises a user selection of at least one of a back camera and a front camera.

17. The medium of claim 1, wherein the method further comprises:
unlocking the mobile device to a public mode according to the first user identification process; and
unlocking the mobile device to a private mode according to the second user identification.

18. The medium of claim 1, wherein:
the unlocking the mobile device according to the first user identification process further comprises unlocking the mobile device according to the first user identification process and a first time condition; and
the maintaining an unlock state of the mobile device according to the second user identification process further comprises maintaining an unlock state of the mobile device according to the second user identification process and a second time condition.

19. The medium of claim 1, wherein the method further comprises:
unlocking the mobile device to a normal mode according to a main address of a location; and
unlocking the mobile device to the normal mode according to an expanded area including the main address and an adjacent address.

20. The medium of claim 1, wherein the method further comprises:
unlocking the mobile device to a normal mode according to a main address of a location; and
maintaining the normal mode of the mobile device according to an expanded area expanded from the main address to cover an adjacent address.
